(19) United States
(12) Patent Application Publication
(10) Pub. No.: US 2023/0371574 A1
(43) Pub. Date: Nov. 23, 2023

(54) LIQUID NICOTINE FORMULATION AND CARTRIDGE FOR AN AEROSOL-GENERATING SYSTEM

(71) Applicant: Philip Morris Products S.A., Neuchatel (CH)

(72) Inventors: Chiara FASCIANI, Neuchâtel (CH); Felix FRAUENDORFER, Murten (CH)

(73) Assignee: Philip Morris Products S.A., Neuchatel (CH)

(21) Appl. No.: 18/248,399

(22) PCT Filed: Jul. 29, 2021
(86) PCT No.: PCT/EP2021/071337

§ 371 Date: Apr. 10, 2023

(30) Foreign Application Priority Data
Oct. 16, 2020 (EP) 20202428.7

(51) Int. Cl. A24B 15/167; A24F 40/42; A24B 15/30; A24C 5/01

(52) U.S. Cl. CPC A24B 15/167; A24F 40/42; A24B 15/30; A24C 5/01

(57) ABSTRACT

A liquid nicotine formulation for an aerosol-generating system, the liquid nicotine formulation including: nicotine; a liquid carrier; and a plurality of carboxylic acids, the plurality of carboxylic acids including benzoic acid and one or more carboxylic acids selected from the group consisting of acetic acid, adipic acid, fumaric acid, lactic acid, levulinic acid, malic acid, and succinic acid, a molar ratio of total carboxylic acid to nicotine in the liquid nicotine formulation being greater than or equal to about 0.65:1, and a molar ratio of benzoic acid to nicotine in the liquid nicotine formulation being greater than or equal to about 0.2:1. A cartridge for an aerosol-generating system is also provided, the cartridge including a liquid storage portion including the liquid nicotine formulation; and a fluid-permeable heating element in fluid communication with the liquid storage portion.

The invention relates to a liquid nicotine formulation for use in an aerosol-generating system. The invention also relates to a cartridge for an aerosol-generating system comprising the liquid nicotine formulation and an aerosol-generating system comprising the cartridge.

Aerosol-generating systems for delivering nicotine to a user that comprise an atomiser configured to generate an inhalable aerosol from a liquid nicotine formulation are known. Some known aerosol-generating systems comprise a thermal atomiser that is configured to heat the liquid nicotine formulation to generate an aerosol. Other known aerosol-generating systems comprise a non-thermal atomiser that is configured to generate an aerosol from the liquid nicotine formulation using, for example, impinging jet, ultrasonic or vibrating mesh technologies.

Handheld electrically operated aerosol-generating systems comprising a cartridge comprising a liquid storage portion comprising a supply of liquid nicotine formulation and an electrically operated heater configured to heat the liquid nicotine formulation to generate an aerosol, and an aerosol-generating device comprising control electronics and a power source for supplying power to the electrically operated heater, are known.

The heater typically comprises a coil of electrically conductive wire that is wound around an elongate wick, which transports liquid nicotine formulation from the liquid storage portion of the cartridge to the coil of wire. In use, an electric current may be passed through the coil of wire to heat the liquid nicotine formulation to generate an aerosol.

However, in other known handheld electrically operated aerosol-generating systems the heater comprises a fluid permeable heating element comprising an electrically conductive mesh that is in contact with a transport material, which conveys liquid nicotine formulation to the electrically conductive mesh. In use, an electric current may be passed through the electrically conductive mesh to heat the liquid nicotine formulation to generate an aerosol.

A cartridge comprising a supply of liquid nicotine formulation and an atomiser configured to generate an aerosol from the liquid nicotine formulation is sometimes referred to as a “cartomiser”. The liquid storage portion of the cartridge may comprise a retention material for holding the liquid nicotine formulation. The cartridge typically also comprises a mouthpiece portion that a user draws on, in use, in order to inhale the generated aerosol.

Liquid nicotine formulations for use in aerosol-generating systems typically comprise a liquid carrier comprising one or more solvents, such as glycerine, propylene glycol and water, and optionally one or more flavourants. It is also known to include acids in liquid nicotine formulations for use in aerosol-generating systems.

Inclusion of an acid in a liquid nicotine formulation for use in an aerosol-generating system may advantageously enable generation of an inhalable aerosol having improved sensory properties. Inclusion of an acid in a liquid nicotine formulation for use in an aerosol-generating system may advantageously enable generation of an inhalable aerosol providing improved nicotine satisfaction to a user.

However, inclusion of an acid in a liquid nicotine formulation for use in aerosol-generating system may detrimentally affect the stability of the liquid nicotine formulation during storage. For example, inclusion of an acid in a liquid nicotine formulation comprising one or more flavourants may disadvantageously reduce the flavour stability of the liquid nicotine formulation during storage.

Inclusion of a liquid nicotine formulation comprising an acid in a cartridge for use in an aerosol-generating system may disadvantageously lead to corrosion of components of the cartridge during storage. For example, where a cartridge for use in an aerosol-generating system comprises a heater comprising a coil of electrically conductive wire wound around an elongate wick, inclusion of a liquid nicotine formulation comprising an acid in the cartridge may disadvantageously lead to corrosion of the coil of electrically conductive wire. For example, where a cartridge for use in an aerosol-generating system comprises a heater comprising a fluid permeable heating element comprising an electrically conductive mesh in contact with a transport material, inclusion of a liquid nicotine formulation comprising an acid in the cartridge may disadvantageously lead to corrosion of the electrically conductive mesh.

Inclusion of a liquid nicotine formulation comprising an acid in a cartridge for use in an aerosol-generating system may disadvantageously lead to corrosion of metal components of the cartridge during storage. In particular, inclusion of a liquid nicotine formulation comprising an acid in a cartridge for use in an aerosol-generating system may disadvantageously lead to corrosion of non-precious metal components, such as, for example, chromium containing components, copper containing components, nickel containing components, tin containing components and zinc containing components of the cartridge, during storage. For example, cartridges for aerosol-generating systems including a fluid permeable heating element comprising an electrically conductive mesh may comprise one or more non-precious metal containing electrical components. For example, cartridges for aerosol-generating systems including a fluid permeable heating element comprising an electrically conductive mesh may comprise one or non-precious metal containing electrical contacts extending across a portion of the mesh to distribute electrical current across the mesh. Inclusion of a liquid nicotine formulation comprising an acid in such cartridges may disadvantageously result in corrosion of the one or more non-precious metal electrical components.

It would be desirable to provide a liquid nicotine formulation for use in an aerosol-generating system that exhibits improved stability during storage compared to known liquid formulations.

In particular, it would be desirable to provide a liquid nicotine formulation for use in an aerosol-generating system that exhibits improved stability when exposed to non-precious metal containing components during storage compared to known liquid formulations.

According to a first aspect of the invention there is provided a liquid nicotine formulation for use in an aerosol-generating system, the liquid nicotine formulation comprising: nicotine; a liquid carrier; and a plurality of carboxylic acids, wherein the plurality of carboxylic acids comprises at least one carboxylic acid selected from the group consisting of benzoic acid and fumaric acid.

According to the first aspect of the invention there is provided a liquid nicotine formulation for use in an aerosol-generating system, the liquid nicotine formulation comprising: nicotine; a liquid carrier; and a plurality of carboxylic acids, wherein the plurality of carboxylic acids comprises benzoic acid and one or more carboxylic acids selected from the group consisting of acetic acid, adipic acid, fumaric acid, lactic acid, levulinic acid, malic acid, and succinic acid, wherein the molar ratio of total carboxylic acid to nicotine in the liquid nicotine formulation is greater than or equal to about 0.65:1, and wherein the molar ratio of benzoic acid to nicotine in the liquid nicotine formulation is greater than or equal to about 0.2:1.

According to a second aspect of the invention there is provided a cartridge for an aerosol-generating system, the cartridge comprising: a liquid storage portion comprising a liquid nicotine formulation according to the first aspect of the invention; and an atomiser in fluid communication with the liquid storage portion, wherein the atomiser is configured to vaporise the liquid nicotine formulation to generate an aerosol.

According to the second aspect of the invention there is provided a cartridge for an aerosol-generating system, the cartridge comprising: a liquid storage portion comprising a liquid nicotine formulation, wherein the liquid nicotine formulation comprises nicotine, a liquid carrier; and a plurality of carboxylic acids, wherein the plurality of carboxylic acids comprises benzoic acid and one or more carboxylic acids selected from the group consisting of acetic acid, adipic acid, fumaric acid, lactic acid, levulinic acid, malic acid, and succinic acid, wherein the molar ratio of total carboxylic acid to nicotine in the liquid nicotine formulation is greater than or equal to about 0.65:1, and wherein the molar ratio of benzoic acid to nicotine in the liquid nicotine formulation is greater than or equal to about 0.2:1; and an atomiser in fluid communication with the liquid storage portion, wherein the atomiser is configured to vaporise the liquid nicotine formulation to generate an aerosol.

According to a third aspect of the invention there is provided a cartridge for an aerosol-generating system, the cartridge comprising: a liquid storage portion comprising a liquid nicotine formulation, wherein the liquid nicotine formulation comprises nicotine, a liquid carrier, and at least one carboxylic acid selected from the group consisting of benzoic acid and fumaric acid; and a fluid permeable heating element in fluid communication with the liquid storage portion, wherein the fluid permeable heating element comprises an electrically conductive mesh configured to vaporise the liquid nicotine formulation to generate an aerosol.

Cartridges according to the third aspect of the invention may comprise a liquid nicotine formulation according to the first aspect of the invention. That is, cartridges according to the third aspect of the invention may comprise: a liquid storage portion comprising a liquid nicotine formulation, wherein the liquid nicotine formulation comprises nicotine, a liquid carrier, and a plurality of carboxylic acids, wherein the plurality of carboxylic acids comprises at least one carboxylic acid selected from the group consisting of benzoic acid and fumaric acid; and a fluid permeable heating element in fluid communication with the liquid storage portion, wherein the fluid permeable heating element comprises an electrically conductive mesh configured to vaporise the liquid nicotine formulation to generate an aerosol.

According to the third aspect of the invention there is provided a cartridge for an aerosol-generating system, the cartridge comprising: a liquid storage portion comprising a liquid nicotine formulation, wherein the liquid nicotine formulation comprises nicotine, a liquid carrier; and a plurality of carboxylic acids, wherein the plurality of carboxylic acids comprises benzoic acid and one or more carboxylic acids selected from the group consisting of acetic acid, adipic acid, fumaric acid, lactic acid, levulinic acid, malic acid, and succinic acid, wherein the molar ratio of total carboxylic acid to nicotine in the liquid nicotine formulation is greater than or equal to about 0.65:1, and wherein the molar ratio of benzoic acid to nicotine in the liquid nicotine formulation is greater than or equal to about 0.2:1; and a fluid permeable heating element in fluid communication with the liquid storage portion, wherein the fluid permeable heating element comprises an electrically conductive mesh configured to vaporise the liquid nicotine formulation to generate an aerosol.

According to a fourth aspect of the invention there is provided an aerosol-generating system comprising a cartridge according to the second or third aspect of the invention; and an aerosol-generating device configured to be removably coupled to the cartridge.

It has been surprisingly found that inclusion of at least one carboxylic acid selected from the group consisting of benzoic acid and fumaric acid in the liquid nicotine formulation may advantageously improve the stability of liquid nicotine formulations according to the first aspect of the invention during storage.

In particular, it has surprisingly been found that inclusion of at least one carboxylic acid selected from the group consisting of benzoic acid and fumaric acid in the liquid nicotine formulation may advantageously improve the flavour stability of liquid nicotine formulations according to the first aspect of the invention during storage.

It has surprisingly been found that inclusion of at least one carboxylic acid selected from the group consisting of benzoic acid and fumaric acid in the liquid nicotine formulation may advantageously inhibit corrosion of metal components of cartridges according to the second and third aspects of the invention.

In particular, it has surprisingly been found that inclusion of at least one carboxylic acid selected from the group consisting of benzoic acid and fumaric acid in the liquid nicotine formulation may advantageously inhibit corrosion of non-precious metal containing components of cartridges according to the third aspect of the invention.

As used herein with reference to the invention, the term “liquid nicotine formulation” describes a liquid formulation comprising nicotine.

Unless stated otherwise, as used herein with reference to the invention, the term “the liquid nicotine formulation” refers to both liquid nicotine formulations according to the first aspect of the invention and liquid nicotine formulations in cartridges according to the third aspect of the invention.

Unless stated otherwise, as used herein with reference to the invention, the term “the cartridge” refers to cartridges according to both the second and third aspects of the invention.

Unless stated otherwise, percentages by weight of components of the liquid nicotine formulation recited herein are based on the total weight of the liquid nicotine formulation.

As used herein with reference to the invention, the term “aerosol” describes a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

Liquid nicotine formulations according to the first aspect of the invention comprise a plurality of carboxylic acids. That is, liquid nicotine formulations according to the first aspect of the invention comprise two or more carboxylic acids. For example, liquid nicotine formulations according to the first aspect of the invention may comprise two carboxylic acids, three carboxylic acids, four carboxylic acids, or five carboxylic acids.

The plurality of carboxylic acids comprises at least one carboxylic acid selected from the group consisting of benzoic acid and fumaric acid.

The plurality of carboxylic acids may comprise benzoic acid and fumaric acid.

In addition to at least one carboxylic acid selected from the group consisting of benzoic acid and fumaric acid, the plurality of carboxylic acids may comprise one or more carboxylic acids selected from the group consisting of acetic acid, adipic acid, lactic acid, levulinic acid, malic acid, salicyclic acid, succinic acid, and tartaric acid.

The plurality of carboxylic acids may comprise benzoic acid and one or more carboxylic acids selected from the group consisting of acetic acid, adipic acid, fumaric acid, lactic acid, levulinic acid, malic acid, salicyclic acid, succinic acid, and tartaric acid.

The plurality of carboxylic acids may comprise benzoic acid and one or more carboxylic acids selected from the group consisting of acetic acid, adipic acid, lactic acid, levulinic acid, malic acid, salicyclic acid, succinic acid, and tartaric acid.

The plurality of carboxylic acids may comprise fumaric acid and one or more carboxylic acids selected from the group consisting of acetic acid, adipic acid, lactic acid, levulinic acid, malic acid, salicyclic acid, succinic acid, and tartaric acid.

The plurality of carboxylic acids may comprise fumaric acid and one or more carboxylic acids selected from the group consisting of acetic acid, adipic acid, benzoic acid, lactic acid, levulinic acid, malic acid, salicyclic acid, succinic acid, and tartaric acid.

The plurality of carboxylic acids may comprise benzoic acid, fumaric acid, and one or more carboxylic acids selected from the group consisting of acetic acid, adipic acid, lactic acid, levulinic acid, malic acid, salicyclic acid, succinic acid, and tartaric acid.

In addition to at least one carboxylic acid selected from the group consisting of benzoic acid and fumaric acid, the plurality of carboxylic acids may comprise one or more carboxylic acids selected from the group consisting of acetic acid, adipic acid, lactic acid, levulinic acid, malic acid, and succinic acid.

The plurality of carboxylic acids may comprise benzoic acid and one or more carboxylic acids selected from the group consisting of acetic acid, adipic acid, fumaric acid, lactic acid, levulinic acid, malic acid, and succinic acid.

The plurality of carboxylic acids may comprise benzoic acid and one or more carboxylic acids selected from the group consisting of acetic acid, adipic acid, lactic acid, levulinic acid, malic acid, and succinic acid.

The plurality of carboxylic acids may comprise fumaric acid and one or more carboxylic acids selected from the group consisting of acetic acid, adipic acid, benzoic acid, lactic acid, levulinic acid, malic acid, and succinic acid.

The plurality of carboxylic acids may comprise fumaric acid and one or more carboxylic acids selected from the group consisting of acetic acid, adipic acid, lactic acid, levulinic acid, malic acid, and succinic acid.

The plurality of carboxylic acids may comprise benzoic acid, fumaric acid, and one or more carboxylic acids selected from the group consisting of acetic acid, adipic acid, lactic acid, levulinic acid, malic acid, and succinic acid.

In addition to at least one carboxylic acid selected from the group consisting of benzoic acid and fumaric acid, the plurality of carboxylic acids may comprise at least one carboxylic acid selected from the group consisting of acetic acid and lactic acid.

The plurality of carboxylic acids may comprise benzoic acid and at least one carboxylic acid selected from the group consisting of acetic acid, fumaric acid and lactic acid.

The plurality of carboxylic acids may comprise benzoic acid and at least one carboxylic acid selected from the group consisting of acetic acid and lactic acid.

The plurality of carboxylic acids may comprise fumaric acid and at least one carboxylic acid selected from the group consisting of acetic acid, benzoic acid and lactic acid.

The plurality of carboxylic acids may comprise fumaric acid and at least one carboxylic acid selected from the group consisting of acetic acid and lactic acid.

The plurality of carboxylic acids may comprise benzoic acid, fumaric acid, and at least one carboxylic acid selected from the group consisting of acetic acid and lactic acid.

In addition to at least one carboxylic acid selected from the group consisting of benzoic acid and fumaric acid, the plurality of carboxylic acids may comprise lactic acid.

The plurality of carboxylic acids may comprise benzoic acid and at least one carboxylic acid selected from the group consisting of fumaric acid and lactic acid.

The plurality of carboxylic acids may comprise benzoic acid and lactic acid.

The plurality of carboxylic acids may comprise fumaric acid and at least one carboxylic acid selected from the group consisting of benzoic acid and lactic acid.

The plurality of carboxylic acids may comprise fumaric acid and lactic acid.

The plurality of carboxylic acids may comprise benzoic acid, fumaric acid, and lactic acid.

As used herein with reference to the invention, the term “total carboxylic acid content” describes the combined content of all carboxylic acids in the liquid nicotine formulation. For example, where the liquid nicotine formulation comprises a plurality of carboxylic acids consisting of benzoic acid and fumaric acid, the term “total carboxylic acid content” describes the combined benzoic acid content and fumaric acid content of the liquid nicotine formulation.

The liquid nicotine formulation may have a total carboxylic acid content of greater than or equal to about 0.1 percent by weight, greater than or equal to about 0.5 percent by weight, greater than or equal to about 1 percent by weight, greater than or equal to about 1.5 percent by weight, greater than or equal to about 2 percent by weight, or greater than or equal to about 2.5 percent by weight

The liquid nicotine formulation may have a total carboxylic acid content of less than or equal to about 7 percent by weight, less than or equal to about 6 percent by weight, less than or equal to about 5 percent by weight, less than or equal to about 4 percent by weight, or less than or equal to about 3 percent by weight.

The liquid nicotine formulation may have a total carboxylic acid content of between about 0.1 percent by weight and about 7 percent by weight, between about 0.1 percent by weight and about 6 percent by weight, between about 0.1 percent by weight and about 5 percent by weight, between about 0.1 percent by weight and about 4 percent by weight, or between about 0.1 percent by weight and about 3 percent by weight.

The liquid nicotine formulation may have a total carboxylic acid content of between about 0.5 percent by weight and about 7 percent by weight, between about 0.5 percent by weight and about 6 percent by weight, between about 0.5 percent by weight and about 5 percent by weight, between about 0.5 percent by weight and about 4 percent by weight, or between about 0.5 percent by weight and about 3 percent by weight.

The liquid nicotine formulation may have a total carboxylic acid content of between about 1 percent by weight and about 7 percent by weight, between about 1 percent by weight and about 6 percent by weight, between about 1 percent by weight and about 5 percent by weight, between about 1 percent by weight and about 4 percent by weight, or between about 1 percent by weight and about 3 percent by weight.

The liquid nicotine formulation may have a total carboxylic acid content of between about 1.5 percent by weight and about 7 percent by weight, between about 1.5 percent by weight and about 6 percent by weight, between about 1.5 percent by weight and about 5 percent by weight, between about 1.5 percent by weight and about 4 percent by weight, or between about 1.5 percent by weight and about 3 percent by weight.

The liquid nicotine formulation may have a total carboxylic acid content of between about 2 percent by weight and about 7 percent by weight, between about 2 percent by weight and about 6 percent by weight, between about 2 percent by weight and about 5 percent by weight, between about 2 percent by weight and about 4 percent by weight, or between about 2 percent by weight and about 3 percent by weight.

The liquid nicotine formulation may have a total carboxylic acid content of between about 2.5 percent by weight and about 7 percent by weight, between about 2.5 percent by weight and about 6 percent by weight, between about 2.5 percent by weight and about 5 percent by weight, between about 2.5 percent by weight and about 4 percent by weight, or between about 2.5 percent by weight and about 3 percent by weight.

The molar ratio of total carboxylic acid to nicotine in the liquid nicotine formulation may be greater than or equal to about 0.65:1, greater than or equal to about 0.7:1 or greater than or equal to about 0.75:1.

The molar ratio of total carboxylic acid to nicotine in the liquid nicotine formulation may be less than or equal to about 1.4:1, less than or equal to about 1.3:1, or less than or equal to about 1.2:1.

The molar ratio of total carboxylic acid to nicotine in the liquid nicotine formulation may be between about 0.65:1 and about 1.4:1, between about 0.65:1 and about 1.3:1, or between about 0.65:1 and about 1.2:1.

The molar ratio of total carboxylic acid to nicotine in the liquid nicotine formulation may be between about 0.7:1 and about 1.4:1, between about 0.7:1 and about 1.3:1, or between about 0.7:1 and about 1.2:1.

The molar ratio of total carboxylic acid to nicotine in the liquid nicotine formulation may be between about 0.75:1 and about 1.4:1, between about 0.75:1 and about 1.3:1, or between about 0.75:1 and about 1.2:1.

In embodiments in which the liquid nicotine formulation comprises benzoic acid, the molar ratio of benzoic acid to nicotine in the liquid nicotine formulation may be greater than or equal to about 0.2:1, greater than or equal to about 0.3:1, greater than or equal to about 0.4:1, or greater than or equal to about 0.5:1.

In embodiments in which the liquid nicotine formulation comprises benzoic acid, the molar ratio of benzoic acid to nicotine in the liquid nicotine formulation may be less than or equal to about 1:1, less than or equal to about 0.9:1, less than or equal to about 0.8:1, or less than or equal to about 0.7:1.

In embodiments in which the liquid nicotine formulation comprises benzoic acid, the molar ratio of benzoic acid to nicotine in the liquid nicotine formulation may be between about 0.2:1 and about 1:1, between about 0.2:1 and about 0.9:1, between about 0.2:1 and about 0.8:1, or between about 0.2:1 and about 0.7:1.

In embodiments in which the liquid nicotine formulation comprises benzoic acid, the molar ratio of benzoic acid to nicotine in the liquid nicotine formulation may be between about 0.3:1 and about 1:1, between about 0.3:1 and about 0.9:1, between about 0.3:1 and about 0.8:1, or between about 0.3:1 and about 0.7:1.

In embodiments in which the liquid nicotine formulation comprises benzoic acid, the molar ratio of benzoic acid to nicotine in the liquid nicotine formulation may be between about 0.4:1 and about 1:1, between about 0.4:1 and about 0.9:1, between about 0.4:1 and about 0.8:1, or between about 0.4:1 and about 0.7:1.

In embodiments in which the liquid nicotine formulation comprises benzoic acid, the molar ratio of benzoic acid to nicotine in the liquid nicotine formulation may be between about 0.5:1 and about 1:1, between about 0.5:1 and about 0.9:1, between about 0.5:1 and about 0.8:1, or between about 0.5:1 and about 0.7:1.

In embodiments in which the liquid nicotine formulation comprises benzoic acid, the molar ratio of benzoic acid to total carboxylic acid in the liquid nicotine formulation may be greater than or equal to about 0.1:1, greater than or equal to about 0.2:1, greater than or equal to about 0.3:1, greater than or equal to about 0.4:1, or greater than or equal to about 0.5:1.

In embodiments in which the liquid nicotine formulation comprises benzoic acid, the molar ratio of benzoic acid to total carboxylic acid in the liquid nicotine formulation may be less than or equal to about 0.95:1, less than or equal to about 0.9:1, less than or equal to about 0.85:1, or less than or equal to about 0.8:1.

In embodiments in which the liquid nicotine formulation comprises benzoic acid, the molar ratio of benzoic acid to total carboxylic acid in the liquid nicotine formulation may be between about 0.1:1 and about 0.95:1, between about 0.1:1 and about 0.9:1, between about 0.1:1 and about 0.85:1, or between about 0.1:1 and about 0.8:1.

In embodiments in which the liquid nicotine formulation comprises benzoic acid, the molar ratio of benzoic acid to total carboxylic acid in the liquid nicotine formulation may be between about 0.2:1 and about 0.95:1, between about 0.2:1 and about 0.9:1, between about 0.2:1 and about 0.85:1, or between about 0.2:1 and about 0.8:1.

In embodiments in which the liquid nicotine formulation comprises benzoic acid, the molar ratio of benzoic acid to total carboxylic acid in the liquid nicotine formulation may be between about 0.3:1 and about 0.95:1, between about 0.3:1 and about 0.9:1, between about 0.3:1 and about 0.85:1, or between about 0.3:1 and about 0.8:1.

In embodiments in which the liquid nicotine formulation comprises benzoic acid, the molar ratio of benzoic acid to total carboxylic acid in the liquid nicotine formulation may be between about 0.4:1 and about 0.95:1, between about 0.4:1 and about 0.9:1, between about 0.4:1 and about 0.85:1, or between about 0.4:1 and about 0.8:1.

In embodiments in which the liquid nicotine formulation comprises benzoic acid, the molar ratio of benzoic acid to total carboxylic acid in the liquid nicotine formulation may be between about 0.5:1 and about 0.95:1, between about 0.5:1 and about 0.9:1, between about 0.5:1 and about 0.85:1, or between about 0.5:1 and about 0.8:1.

In embodiments in which the liquid nicotine formulation comprises fumaric acid, the molar ratio of fumaric acid to nicotine in the liquid nicotine formulation may be greater than or equal to about 0.05:1, greater than or equal to about 0.1:1, greater than or equal to about 0.15:1, or greater than or equal to about 0.2:1.

In embodiments in which the liquid nicotine formulation comprises fumaric acid, the molar ratio of fumaric acid to nicotine in the liquid nicotine formulation may be less than or equal to about 0.9:1, less than or equal to about 0.8:1, less than or equal to about 0.7:1, or less than or equal to about 0.6:1.

In embodiments in which the liquid nicotine formulation comprises fumaric acid, the molar ratio of fumaric acid to nicotine in the liquid nicotine formulation may be between about 0.05:1 and about 0.9:1, between about 0.05:1 and about 0.8:1, between about 0.05:1 and about 0.7:1, or between about 0.05:1 and about 0.6:1.

In embodiments in which the liquid nicotine formulation comprises fumaric acid, the molar ratio of fumaric acid to nicotine in the liquid nicotine formulation may be between about 0.1:1 and about 0.9:1, between about 0.1:1 and about 0.8:1, between about 0.1:1 and about 0.7:1, or between about 0.1:1 and about 0.6:1.

In embodiments in which the liquid nicotine formulation comprises fumaric acid, the molar ratio of fumaric acid to nicotine in the liquid nicotine formulation may be between about 0.15:1 and about 0.9:1, between about 0.15:1 and about 0.8:1, between about 0.15:1 and about 0.7:1, or between about 0.15:1 and about 0.6:1.

In embodiments in which the liquid nicotine formulation comprises fumaric acid, the molar ratio of fumaric acid to nicotine in the liquid nicotine formulation may be between about 0.2:1 and about 0.9:1, between about 0.2:1 and about 0.8:1, between about 0.2:1 and about 0.7:1, or between about 0.2:1 and about 0.6:1.

In embodiments in which the liquid nicotine formulation comprises fumaric acid, the molar ratio of fumaric acid to total carboxylic acid in the liquid nicotine formulation may be greater than or equal to about 0.05:1, greater than or equal to about 0.1:1, greater than or equal to about 0.15:1, or greater than or equal to about 0.2:1.

In embodiments in which the liquid nicotine formulation comprises fumaric acid, the molar ratio of fumaric acid to total carboxylic acid in the liquid nicotine formulation may be less than or equal to about 0.95:1, less than or equal to about 0.8:1, less than or equal to about 0.7:1, or less than or equal to about 0.6:1.

In embodiments in which the liquid nicotine formulation comprises fumaric acid, the molar ratio of fumaric acid to total carboxylic acid in the liquid nicotine formulation may be between about 0.05:1 and about 0.95:1, between about 0.05:1 and about 0.8:1, between about 0.05:1 and about 0.7:1, or between about 0.05:1 and about 0.6:1.

In embodiments in which the liquid nicotine formulation comprises fumaric acid, the molar ratio of fumaric acid to total carboxylic acid in the liquid nicotine formulation may be between about 0.1:1 and about 0.95:1, between about 0.1:1 and about 0.8:1, between about 0.1:1 and about 0.7:1, or between about 0.1:1 and about 0.6:1.

In embodiments in which the liquid nicotine formulation comprises fumaric acid, the molar ratio of fumaric acid to total carboxylic acid in the liquid nicotine formulation may be between about 0.15:1 and about 0.95:1, between about 0.15:1 and about 0.8:1, between about 0.15:1 and about 0.7:1, or between about 0.15:1 and about 0.6:1.

In embodiments in which the liquid nicotine formulation comprises fumaric acid, the molar ratio of fumaric acid to total carboxylic acid in the liquid nicotine formulation may be between about 0.2:1 and about 0.95:1, between about 0.2:1 and about 0.8:1, between about 0.2:1 and about 0.7:1, or between about 0.2:1 and about 0.6:1.

The liquid nicotine formulation may comprise natural nicotine, or synthetic nicotine, or a combination of natural nicotine and synthetic nicotine.

The liquid nicotine formulation may have a nicotine content of greater than or equal to about 0.5 percent by weight, greater than or equal to about 1 percent by weight, greater than or equal to about 1.5 percent by weight, greater than or equal to about 2 percent by weight, greater than or equal to about 2.5 percent by weight, greater than or equal to about 3 percent by weight, or greater than or equal to about 3.5 percent by weight.

The liquid nicotine formulation may have a nicotine content of less than or equal to about 8 percent by weight, less than or equal to about 7 percent by weight, less than or equal to about 6 percent by weight, less than or equal to about 5 percent by weight, or less than or equal to about 4 percent by weight.

The liquid nicotine formulation may have a nicotine content of between about 0.5 percent by weight and about 8 percent by weight, between about 0.5 percent by weight and about 7 percent by weight, between about 0.5 percent by weight and about 6 percent by weight, between about 0.5 percent by weight and about 5 percent by weight, or between about 0.5 percent by weight and about 4 percent by weight.

The liquid nicotine formulation may have a nicotine content of between about 1 percent by weight and about 8 percent by weight, between about 1 percent by weight and about 7 percent by weight, between about 1 percent by weight and about 6 percent by weight, between about 1 percent by weight and about 5 percent by weight, or between about 1 percent by weight and about 4 percent by weight.

The liquid nicotine formulation may have a nicotine content of between about 1.5 percent by weight and about 8 percent by weight, between about 1.5 percent by weight and about 7 percent by weight, between about 1.5 percent by weight and about 6 percent by weight, between about 1.5 percent by weight and about 5 percent by weight, or between about 1.5 percent by weight and about 4 percent by weight.

The liquid nicotine formulation may have a nicotine content of between about 2 percent by weight and about 8 percent by weight, between about 2 percent by weight and about 7 percent by weight, between about 2 percent by weight and about 6 percent by weight, between about 2 percent by weight and about 5 percent by weight, or between about 2 percent by weight and about 4 percent by weight.

The liquid nicotine formulation may have a nicotine content of between about 2.5 percent by weight and about 8 percent by weight, between about 2.5 percent by weight and about 7 percent by weight, between about 2.5 percent by weight and about 6 percent by weight, between about 2.5 percent by weight and about 5 percent by weight, or between about 2.5 percent by weight and about 4 percent by weight.

The liquid nicotine formulation may have a nicotine content of between about 3 percent by weight and about 8 percent by weight, between about 3 percent by weight and about 7 percent by weight, between about 3 percent by weight and about 6 percent by weight, between about 3 percent by weight and about 5 percent by weight, or between about 3 percent by weight and about 4 percent by weight.

The liquid nicotine formulation may have a nicotine content of between about 3.5 percent by weight and about 8 percent by weight, between about 3.5 percent by weight and about 7 percent by weight, between about 3.5 percent by weight and about 6 percent by weight, between about 3.5 percent by weight and about 5 percent by weight, or between about 3.5 percent by weight and about 4 percent by weight.

The liquid nicotine formulation may have a liquid carrier content of greater than or equal to about 80 percent by weight, greater than or equal to about 85 percent by weight, or greater than or equal to about 90 percent by weight.

The liquid nicotine formulation may have a liquid carrier content of less than or equal to about 99 percent by weight, less than or equal to about 97 percent by weight, or less than or equal to about 95 percent by weight.

The liquid nicotine formulation may have a liquid carrier content of between about 80 percent by weight and about 99 percent by weight, between about 80 percent by weight and about 97 percent by weight, or between about 80 percent by weight and about 95 percent by weight.

The liquid nicotine formulation may have a liquid carrier content of between about 85 percent by weight and about 99 percent by weight, between about 85 percent by weight and about 97 percent by weight, or between about 85 percent by weight and about 95 percent by weight.

The liquid nicotine formulation may have a liquid carrier content of between about 90 percent by weight and about 99 percent by weight, between about 90 percent by weight and about 97 percent by weight, or between about 90 percent by weight and about 95 percent by weight.

The liquid carrier may comprise one or more biologically acceptable solvents.

The liquid carrier may comprise one or more medium chain triglycerides.

The liquid carrier may comprise one or more polyhydric alcohols.

In embodiments in which the liquid carrier comprises one or more polyhydric alcohols, the liquid nicotine formulation may have a polyhydric alcohol content of greater than or equal to about 60 percent by weight, greater than or equal to about 70 percent by weight, greater than or equal to about 80 percent by weight, greater than or equal to about 85 percent by weight, or greater than or equal to about 90 percent by weight.

In embodiments in which the liquid carrier comprises one or more polyhydric alcohols, the liquid nicotine formulation may have a polyhydric alcohol content of less than or equal to about 99 percent by weight, less than or equal to about 97 percent by weight, or less than or equal to about 95 percent by weight.

In embodiments in which the liquid carrier comprises one or more polyhydric alcohols, the liquid nicotine formulation may have a polyhydric alcohol content of between about 60 percent by weight and about 99 percent by weight, between about 60 percent by weight and about 97 percent by weight, or between about 60 percent by weight and about 95 percent by weight.

In embodiments in which the liquid carrier comprises one or more polyhydric alcohols, the liquid nicotine formulation may have a polyhydric alcohol content of between about 70 percent by weight and about 99 percent by weight, between about 70 percent by weight and about 97 percent by weight, or between about 70 percent by weight and about 95 percent by weight.

In embodiments in which the liquid carrier comprises one or more polyhydric alcohols, the liquid nicotine formulation may have a polyhydric alcohol content of between about 80 percent by weight and about 99 percent by weight, between about 80 percent by weight and about 97 percent by weight, or between about 80 percent by weight and about 95 percent by weight.

In embodiments in which the liquid carrier comprises one or more polyhydric alcohols, the liquid nicotine formulation may have a polyhydric alcohol content of between about 85 percent by weight and about 99 percent by weight, between about 85 percent by weight and about 97 percent by weight, or between about 85 percent by weight and about 95 percent by weight.

In embodiments in which the liquid carrier comprises one or more polyhydric alcohols, the liquid nicotine formulation may have a polyhydric alcohol content of between about 90 percent by weight and about 99 percent by weight, between about 90 percent by weight and about 97 percent by weight, or between about 90 percent by weight and about 95 percent by weight.

The liquid carrier may comprise one or more polyhydric alcohols selected from the group consisting of 1,3-propanediol, 1,3-butanediol, glycerine, propylene glycol, and triethylene glycol.

Preferably, the liquid carrier comprises at least one polyhydric alcohol selected from the group consisting of glycerine and propylene glycol.

More preferably, the liquid carrier comprises at least one polyhydric alcohol selected from the group consisting of vegetable glycerine and propylene glycol.

In embodiments in which the liquid carrier comprises at least one polyhydric alcohol selected from the group consisting of glycerine and propylene glycol, the liquid nicotine formulation may have a combined glycerine and propylene glycol content of greater than or equal to about 60 percent by weight, greater than or equal to about 70 percent by weight, greater than or equal to about 80 percent by weight, greater than or equal to about 85 percent by weight, or greater than or equal to about 90 percent by weight.

In embodiments in which the liquid carrier comprises at least one polyhydric alcohol selected from the group consisting of glycerine and propylene glycol, the liquid nicotine formulation may have a combined glycerine and propylene glycol content of less than or equal to about 99 percent by weight, less than or equal to about 97 percent by weight, or less than or equal to about 95 percent by weight.

In embodiments in which the liquid carrier comprises at least one polyhydric alcohol selected from the group consisting of glycerine and propylene glycol, the liquid nicotine formulation may have a combined glycerine and propylene glycol content of between about 60 percent by weight and about 99 percent by weight, between about 60 percent by weight and about 97 percent by weight, or between about 60 percent by weight and about 95 percent by weight.

In embodiments in which the liquid carrier comprises at least one polyhydric alcohol selected from the group consisting of glycerine and propylene glycol, the liquid nicotine formulation may have a combined glycerine and propylene glycol content of between about 70 percent by weight and about 99 percent by weight, between about 70 percent by weight and about 97 percent by weight, or between about 70 percent by weight and about 95 percent by weight.

In embodiments in which the liquid carrier comprises at least one polyhydric alcohol selected from the group consisting of glycerine and propylene glycol, the liquid nicotine formulation may have a combined glycerine and propylene glycol content of between about 80 percent by weight and about 99 percent by weight, between about 80 percent by weight and about 97 percent by weight, or between about 80 percent by weight and about 95 percent by weight.

In embodiments in which the liquid carrier comprises at least one polyhydric alcohol selected from the group consisting of glycerine and propylene glycol, the liquid nicotine formulation may have a combined glycerine and propylene glycol content of between about 85 percent by weight and about 99 percent by weight, between about 85 percent by weight and about 97 percent by weight, or between about 85 percent by weight and about 95 percent by weight.

In embodiments in which the liquid carrier comprises at least one polyhydric alcohol selected from the group consisting of glycerine and propylene glycol, the liquid nicotine formulation may have a combined glycerine and propylene glycol content of between about 90 percent by weight and about 99 percent by weight, between about 90 percent by weight and about 97 percent by weight, or between about 90 percent by weight and about 95 percent by weight.

Preferably, the liquid carrier comprises glycerine and propylene glycol.

More preferably, the liquid carrier comprises vegetable glycerine and propylene glycol.

In embodiments in which the liquid carrier comprises glycerine and propylene glycol, the liquid nicotine formulation may have a combined glycerine and propylene glycol content of greater than or equal to about 60 percent by weight, greater than or equal to about 70 percent by weight, greater than or equal to about 80 percent by weight, greater than or equal to about 85 percent by weight, or greater than or equal to about 90 percent by weight.

In embodiments in which the liquid carrier comprises glycerine and propylene glycol, the liquid nicotine formulation may have a combined glycerine and propylene glycol content of less than or equal to about 99 percent by weight, less than or equal to about 97 percent by weight, or less than or equal to about 95 percent by weight.

In embodiments in which the liquid carrier comprises glycerine and propylene glycol, the liquid nicotine formulation may have a combined glycerine and propylene glycol content of between about 60 percent by weight and about 99 percent by weight, between about 60 percent by weight and about 97 percent by weight, or between about 60 percent by weight and about 95 percent by weight.

In embodiments in which the liquid carrier comprises glycerine and propylene glycol, the liquid nicotine formulation may have a combined glycerine and propylene glycol content of between about 70 percent by weight and about 99 percent by weight, between about 70 percent by weight and about 97 percent by weight, or between about 70 percent by weight and about 95 percent by weight.

In embodiments in which the liquid carrier comprises glycerine and propylene glycol, the liquid nicotine formulation may have a combined glycerine and propylene glycol content of between about 80 percent by weight and about 99 percent by weight, between about 80 percent by weight and about 97 percent by weight, or between about 80 percent by weight and about 95 percent by weight.

In embodiments in which the liquid carrier comprises glycerine and propylene glycol, the liquid nicotine formulation may have a combined glycerine and propylene glycol content of between about 85 percent by weight and about 99 percent by weight, between about 85 percent by weight and about 97 percent by weight, or between about 85 percent by weight and about 95 percent by weight.

In embodiments in which the liquid carrier comprises glycerine and propylene glycol, the liquid nicotine formulation may have a combined glycerine and propylene glycol content of between about 90 percent by weight and about 99 percent by weight, between about 90 percent by weight and about 97 percent by weight, or between about 90 percent by weight and about 95 percent by weight.

Increasing the proportion of propylene glycol in the liquid nicotine formulation may improve the ability of the liquid nicotine formulation dissolve flavours.

Increasing the proportion of glycerine in the liquid nicotine formulation may increase the volume of visible aerosol generated from the liquid nicotine formulation.

In embodiments in which the liquid carrier comprises glycerine and propylene glycol, the ratio of the weight percent glycerine content to the weight percent propylene glycol content of the liquid nicotine formulation may be greater than or equal to about 0.2:1, greater than or equal to about 0.4:1, greater than or equal to about 0.6:1, greater than or equal to about 0.8:1, or greater than or equal to about 0.9:1.

In embodiments in which the liquid carrier comprises glycerine and propylene glycol, the ratio of the weight percent glycerine content to the weight percent propylene glycol content of the liquid nicotine formulation may be less than or equal to about 2:1, less than or equal to about 1.8:1, less than or equal to about 1.6:1, less than or equal to about 1.4:1, less than or equal to about 1.2:1, or less than or equal to about 1.1:1.

In embodiments in which the liquid carrier comprises glycerine and propylene glycol, the ratio of the weight percent glycerine content to the weight percent propylene glycol content of the liquid nicotine formulation may be between about 0.2:1 and about 2:1, between about 0.2:1 and about 1.8:1, between about 0.2:1 and about 1.6:1, between about 0.2:1 and about 1.4:1, between about 0.2:1 about 1.2:1, or between about 0.2:1 about 1.1:1.

In embodiments in which the liquid carrier comprises glycerine and propylene glycol, the ratio of the weight percent glycerine content to the weight percent propylene glycol content of the liquid nicotine formulation may be between about 0.4:1 and about 2:1, between about 0.4:1 and about 1.8:1, between about 0.4:1 and about 1.6:1, between about 0.4:1 and about 1.4:1, between about 0.4:1 about 1.2:1, or between about 0.4:1 about 1.1:1.

In embodiments in which the liquid carrier comprises glycerine and propylene glycol, the ratio of the weight percent glycerine content to the weight percent propylene glycol content of the liquid nicotine formulation may be between about 0.6:1 and about 2:1, between about 0.6:1 and about 1.8:1, between about 0.6:1 and about 1.6:1, between about 0.6:1 and about 1.4:1, between about 0.6:1 about 1.2:1, or between about 0.6:1 about 1.1:1.

In embodiments in which the liquid carrier comprises glycerine and propylene glycol, the ratio of the weight percent glycerine content to the weight percent propylene glycol content of the liquid nicotine formulation may be between about 0.8:1 and about 2:1, between about 0.8:1 and about 1.8:1, between about 0.8:1 and about 1.6:1, between about 0.8:1 and about 1.4:1, between about 0.8:1 about 1.2:1, or between about 0.8:1 about 1.1:1.

In embodiments in which the liquid carrier comprises glycerine and propylene glycol, the ratio of the weight percent glycerine content to the weight percent propylene glycol content of the liquid nicotine formulation may be between about 0.9:1 and about 2:1, between about 0.9:1 and about 1.8:1, between about 0.9:1 and about 1.6:1, between about 0.9:1 and about 1.4:1, between about 0.9:1 about 1.2:1, or between about 0.9:1 about 1.1:1.

In embodiments in which the liquid carrier comprises glycerine and propylene glycol, the ratio of the weight percent glycerine content to the weight percent propylene glycol content of the liquid nicotine formulation may be about 1:1.

In embodiments in which the liquid carrier comprises glycerine and propylene glycol, the liquid nicotine formulation may have a glycerine content of greater than or equal to about 20 percent by weight, greater than or equal to about 25 percent by weight, or greater than or equal to about 30 percent by weight.

In embodiments in which the liquid carrier comprises glycerine and propylene glycol, the liquid nicotine formulation may have a glycerine content of less than or equal to about 60 percent by weight, less than or equal to about 55 percent by weight, or less than or equal to about 50 percent by weight.

In embodiments in which the liquid carrier comprises glycerine and propylene glycol, the liquid nicotine formulation may have a glycerine content of between about 20 percent by weight and about 60 percent by weight, between about 20 percent by weight and about 55 percent by weight, or between about 20 percent by weight and about 50 percent by weight.

In embodiments in which the liquid carrier comprises glycerine and propylene glycol, the liquid nicotine formulation may have a glycerine content of between about 25 percent by weight and about 60 percent by weight, between about 25 percent by weight and about 55 percent by weight, or between about 25 percent by weight and about 50 percent by weight.

In embodiments in which the liquid carrier comprises glycerine and propylene glycol, the liquid nicotine formulation may have a glycerine content of between about 30 percent by weight and about 60 percent by weight, between about 30 percent by weight and about 55 percent by weight, or between about 30 percent by weight and about 50 percent by weight.

In embodiments in which the liquid carrier comprises glycerine and propylene glycol, the liquid nicotine formulation may have a propylene glycol content of greater than or equal to about 20 percent by weight, greater than or equal to about 25 percent by weight, or greater than or equal to about 30 percent by weight.

In embodiments in which the liquid carrier comprises glycerine and propylene glycol, the liquid nicotine formulation may have a propylene glycol content of less than or equal to about 60 percent by weight, less than or equal to about 55 percent by weight, or less than or equal to about 50 percent by weight.

In embodiments in which the liquid carrier comprises glycerine and propylene glycol, the liquid nicotine formulation may have a propylene glycol content of between about 20 percent by weight and about 60 percent by weight, between about 20 percent by weight and about 55 percent by weight, or between about 20 percent by weight and about 50 percent by weight.

In embodiments in which the liquid carrier comprises glycerine and propylene glycol, the liquid nicotine formulation may have a propylene glycol content of between about 25 percent by weight and about 60 percent by weight, between about 25 percent by weight and about 55 percent by weight, or between about 25 percent by weight and about 50 percent by weight.

In embodiments in which the liquid carrier comprises glycerine and propylene glycol, the liquid nicotine formulation may have a propylene glycol content of between about 30 percent by weight and about 60 percent by weight, between about 30 percent by weight and about 55 percent by weight, or between about 30 percent by weight and about 50 percent by weight.

The liquid carrier may comprise no added water.

The liquid carrier may be substantially water-free.

As used herein with reference to the invention, the term “substantially water-free” describes a liquid nicotine formulation having a water content of less than 0.5 percent by weight.

The liquid carrier may comprise water.

In embodiments in which the liquid carrier comprises water, the water may advantageously help to dissolve and stabilise polar components and ionic components of the liquid nicotine formulation.

In embodiments in which the liquid carrier comprises water, the liquid nicotine formulation may have a water content of greater than or equal to about 1 percent by weight, greater than or equal to about 2 percent by weight, or greater than or equal to about 3 percent by weight.

In embodiments in which the liquid carrier comprises water, the liquid nicotine formulation may have a water content of less than or equal to about 20 percent by weight, less than or equal to about 15 percent by weight, less than or equal to about 10 percent by weight, or less than about 6 percent by weight.

In embodiments in which the liquid nicotine formulation comprises water, the liquid nicotine formulation may have a water content of between about 1 percent by weight and about 20 percent by weight, between about 1 percent by weight and about 15 percent by weight, between about 1 percent by weight and about 10 percent by weight, or between about 1 percent by weight and about 6 percent by weight.

In embodiments in which the liquid nicotine formulation comprises water, the liquid nicotine formulation may have a water content of between about 2 percent by weight and about 20 percent by weight, between about 2 percent by weight and about 15 percent by weight, or between about 2 percent by weight and about 10 percent by weight, or between about 2 percent by weight and about 6 percent by weight.

In embodiments in which the liquid nicotine formulation comprises water, the liquid nicotine formulation may have a water content of between about 3 percent by weight and about 20 percent by weight, between about 3 percent by weight and about 15 percent by weight, between about 3 percent by weight and about 10 percent by weight, or between about 3 percent by weight and about 6 percent by weight.

The liquid nicotine formulation may comprise one or more flavourants. Suitable flavourants include, but are not limited to, menthol.

The liquid nicotine formulation may have a flavourant content of greater than or equal to about 0.05 percent by weight, greater than or equal to about 0.15 percent by weight, greater than or equal to about 0.25 percent by weight, greater than or equal to about 0.5 percent by weight, or greater than or equal to about 0.75 percent by weight.

The liquid nicotine formulation may have a flavourant content of less than or equal to about 6 percent by weight, less than or equal to about 5 percent by weight, less than or equal to about 4 percent by weight, less than or equal to about 3 percent by weight, or less than or equal to about 2 percent by weight.

The liquid nicotine formulation may have a flavourant content of between about 0.05 percent by weight and about 6 percent by weight, between about 0.05 percent by weight and about 5 percent by weight, between about 0.05 percent by weight and about 4 percent by weight, between about 0.05 percent by weight and about 3 percent by weight, or between about 0.05 percent by weight and about 2 percent by weight.

The liquid nicotine formulation may have a flavourant content of between about 0.15 percent by weight and about 6 percent by weight, between about 0.15 percent by weight and about 5 percent by weight, between about 0.15 percent by weight and about 4 percent by weight, between about 0.15 percent by weight and about 3 percent by weight, or between about 0.15 percent by weight and about 2 percent by weight.

The liquid nicotine formulation may have a flavourant content of between about 0.25 percent by weight and about 6 percent by weight, between about 0.25 percent by weight and about 5 percent by weight, between about 0.25 percent by weight and about 4 percent by weight, between about 0.25 percent by weight and about 3 percent by weight, or between about 0.25 percent by weight and about 2 percent by weight.

The liquid nicotine formulation may have a flavourant content of between about 0.5 percent by weight and about 6 percent by weight, between about 0.5 percent by weight and about 5 percent by weight, between about 0.5 percent by weight and about 4 percent by weight, between about 0.5 percent by weight and about 3 percent by weight, or between about 0.5 percent by weight and about 2 percent by weight.

The liquid nicotine formulation may have a flavourant content of between about 0.75 percent by weight and about 6 percent by weight, between about 0.75 percent by weight and about 5 percent by weight, between about 0.75 percent by weight and about 4 percent by weight, between about 0.75 percent by weight and about 3 percent by weight, or between about 0.75 percent by weight and about 2 percent by weight.

The liquid nicotine formulation may have a pH of greater than or equal to about 4, greater than or equal to about 4.5, or greater than or equal to about 5.

The liquid nicotine formulation may have a pH of less than or equal to about 7.5, less than or equal to about 7, or less than or equal to about 6.5.

The liquid nicotine formulation may have a pH of between about 4 and about 7.5, between about 4 and about 7, or between about 4 and about 6.5.

The liquid nicotine formulation may have a pH of between about 4.5 and about 7.5, between about 4.5 and about 7, or between about 4.5 and about 6.5.

The liquid nicotine formulation may have a pH of between about 5 and about 7.5, between about 5 and about 7, or between about 5 and about 6.5.

According to the second aspect of the invention there is provided a cartridge for an aerosol-generating system, the cartridge comprising: a liquid storage portion comprising a liquid nicotine formulation according to the first aspect of the invention; and an atomiser in fluid communication with the liquid storage portion, wherein the atomiser is configured to vaporise the liquid nicotine formulation to generate an aerosol.

According to the second aspect of the invention there is provided a cartridge for an aerosol-generating system, the cartridge comprising: a liquid storage portion comprising a liquid nicotine formulation, wherein the liquid nicotine formulation comprises nicotine, a liquid carrier; and a plurality of carboxylic acids, wherein the plurality of carboxylic acids comprises benzoic acid and one or more carboxylic acids selected from the group consisting of acetic acid, adipic acid, fumaric acid, lactic acid, levulinic acid, malic acid, and succinic acid, wherein the molar ratio of total carboxylic acid to nicotine in the liquid nicotine formulation is greater than or equal to about 0.65:1, and wherein the molar ratio of benzoic acid to nicotine in the liquid nicotine formulation is greater than or equal to about 0.2:1; and an atomiser in fluid communication with the liquid storage portion, wherein the atomiser is configured to vaporise the liquid nicotine formulation to generate an aerosol.

The atomiser may be a thermal atomiser.

As used herein with reference to the invention, the term “thermal atomiser” describes an atomiser that is configured to heat the liquid nicotine formulation to generate an aerosol.

Cartridge according to the second aspect of the invention may comprise any suitable type of thermal atomiser.

The thermal atomiser may comprise a heater. The thermal atomiser may comprise an electric heater. For example, the thermal atomiser may comprise an electric heater comprising a resistive heating element or an inductive heating element.

The heater may comprise a heater coil.

The heater may comprise a fluid permeable heating element comprising an electrically conductive mesh.

The thermal atomiser may comprise a heater and a transport element configured to transport liquid nicotine formulation to the heater.

The transport element may comprise a capillary wick.

The atomiser may be a non-thermal atomiser.

As used herein with reference to the invention, the term “non-thermal atomiser” describes an atomiser that is configured to generate an aerosol from the liquid nicotine formulation by means other than heating.

Cartridges according to the second aspect of the invention may comprise any suitable type of non-thermal atomiser.

For example, the non-thermal atomiser may be an impinging jet atomiser, an ultrasonic atomiser or a vibrating mesh atomiser.

Cartridges according to the second aspect of the invention may comprise one or more non-precious metal containing components.

Cartridges according to the second aspect of the invention may comprise one or more non-precious metal containing components selected from the group consisting of chromium containing components, copper containing components, nickel containing components, tin containing components and zinc containing components.

According to the third aspect of the invention there is provided a cartridge for an aerosol-generating system, the cartridge comprising: a liquid storage portion comprising a liquid nicotine formulation, wherein the liquid nicotine formulation comprises nicotine, a liquid carrier, and at least one carboxylic acid selected from the group consisting of benzoic acid and fumaric acid; and a fluid permeable heating element in fluid communication with the liquid storage portion, wherein the fluid permeable heating element comprises an electrically conductive mesh configured to vaporise the liquid nicotine formulation to generate an aerosol.

According to the third aspect of the invention there is provided a cartridge for an aerosol-generating system, the cartridge comprising: a liquid storage portion comprising a liquid nicotine formulation, wherein the liquid nicotine formulation comprises nicotine, a liquid carrier; and a plurality of carboxylic acids, wherein the plurality of carboxylic acids comprises benzoic acid and one or more carboxylic acids selected from the group consisting of acetic acid, adipic acid, fumaric acid, lactic acid, levulinic acid, malic acid, and succinic acid, wherein the molar ratio of total carboxylic acid to nicotine in the liquid nicotine formulation is greater than or equal to about 0.65:1, and wherein the molar ratio of benzoic acid to nicotine in the liquid nicotine formulation is greater than or equal to about 0.2:1; and a fluid permeable heating element in fluid communication with the liquid storage portion, wherein the fluid permeable heating element comprises an electrically conductive mesh configured to vaporise the liquid nicotine formulation to generate an aerosol.

As used herein with reference to the invention, the term “electrically conductive mesh” refers to an electrically conductive solid material having a plurality of apertures extending therethrough. For example, the electrically conductive mesh may comprise a network of woven or non-woven electrically conductive filaments or wires or a perforated electrically conductive sheet.

The plurality of apertures advantageously allow fluid to permeate through the electrically conductive mesh.

The plurality of apertures may each have a dimension of between about 50 microns and about 150 microns, between about 50 microns and about 100 microns, or between about 50 microns and 80 microns.

The plurality of apertures may each have a dimension of between about 60 microns and about 150 microns, between about 60 microns and about 100 microns, or between about 60 microns and 80 microns.

As used herein with reference to the invention, the “dimension” of an aperture describes a distance measured between two opposing surfaces of an aperture. Thus, where, for example, an aperture is bounded by filaments or wires, the dimension of the aperture does not include a thickness of the wires.

The electrically conductive mesh may be substantially flat.

As used herein with reference to the invention, the term “substantially flat” is used to refer to a substantially two dimensional topological manifold.

The substantially flat electrically conductive mesh may be substantially planar.

The substantially flat mesh heater may be curved along one or more dimensions. For example, the substantially flat mesh heater may be curved to form an arch shape or a dome shape.

The electrically conductive mesh may be heated by any suitable method.

For example, the electrically conductive mesh may be resistively heated or inductively heated.

The electrically conductive mesh may comprise a metal. For example, the electrically conductive mesh may comprise a steel such as stainless steel.

The area of the electrically conductive mesh may be less than about 50 square millimetres, less than about 40 square millimetres, or less than about 30 square millimetres. This may advantageously allow cartridges according to the third aspect of the invention to be incorporated into handheld aerosol-generating systems.

Cartridges according to the third aspect of the invention may comprise one or more non-precious metal containing electrical components.

Cartridges according to the third aspect of the invention may comprise one or more non-precious metal containing electrical components selected from the group consisting of chromium containing electrical components, copper containing electrical components, nickel containing electrical components, tin containing electrical components and zinc containing electrical components.

Cartridges according to the third aspect of the invention may comprise one or more electrical contacts electrically connected to the electrically conductive mesh.

Cartridges according to the third aspect of the invention may comprise one or more non-precious metal containing electrical contacts electrically connected to the electrically conductive mesh.

The electrically conductive mesh may comprise a susceptor material.

According to the fourth aspect of the invention there is further provided an aerosol-generating system comprising a cartridge according to the second or third aspect of the invention; and an aerosol-generating device configured to be removably coupled to the cartridge.

The aerosol-generating system may comprise: a consumable cartridge according to the second or third aspect of the invention; and a reusable aerosol-generating device configured to be removably coupled to the cartridge.

The aerosol-generating device may be configured to be removably coupled to the cartridge using any suitable means. For example, the aerosol-generating device may be configured to be removably coupled to the cartridge via a snap-fit connection or corresponding screw threads.

The aerosol-generating system may comprise: a cartridge according to the second or third aspect of the invention; and an aerosol-generating device comprising a housing defining a device cavity configured to receive at least a portion of the cartridge.

The aerosol-generating device may comprise a power supply and control electronics.

The aerosol-generating device may comprise a battery and control electronics.

The power supply may be configured to supply power to the atomiser when the aerosol-generating device is coupled to the cartridge. For example, the power supply may be configured to resistively heat the atomiser.

The aerosol-generating device may comprise an inductor. For example, the aerosol-generating device may comprise an induction coil.

Below, there is provided a non-exhaustive list of non-limiting examples. Any one or more of the features of these examples may be combined with any one or more features of another example, embodiment, or aspect described herein.
EX1: A liquid nicotine formulation for use in an aerosol-generating system, the liquid nicotine formulation comprising: nicotine; a liquid carrier; and a plurality of carboxylic acids, wherein the plurality of carboxylic acids comprises at least one carboxylic acid selected from the group consisting of benzoic acid and fumaric acid.
EX2: A liquid nicotine formulation according to example EX1 wherein the plurality of carboxylic acids comprises benzoic acid.
EX3: A liquid nicotine formulation according to example EX1 wherein the plurality of carboxylic acids comprises fumaric acid.
EX4: A liquid nicotine formulation according to example EX1 wherein the plurality of carboxylic acids comprises benzoic acid and fumaric acid.
EX5: A liquid nicotine formulation according to any one of examples EX1 to EX4 wherein the plurality of carboxylic acids comprises one or more carboxylic acids selected from the group consisting of acetic acid, adipic acid, lactic acid, levulinic acid, malic acid, salicyclic acid, succinic acid, and tartaric acid.
EX6: A liquid nicotine formulation according to any one of examples EX1 to EX4 wherein the plurality of carboxylic acids comprises one or more carboxylic acids selected from the group consisting of acetic acid, adipic acid, lactic acid, levulinic acid, malic acid, and succinic acid.
EX7: A liquid nicotine formulation for use in an aerosol-generating system, the liquid nicotine formulation comprising: nicotine; a liquid carrier; and a plurality of carboxylic acids, wherein the plurality of carboxylic acids comprises benzoic acid and one or more carboxylic acids selected from the group consisting of acetic acid, adipic acid, fumaric acid, lactic acid, levulinic acid, malic acid, and succinic acid.
EX8: A liquid nicotine formulation according to example EX7 wherein the plurality of carboxylic acids comprises at least one carboxylic acid selected from the group consisting of acetic acid, fumaric acid and lactic acid.
EX9: A liquid nicotine formulation according to example EX7 wherein the plurality of carboxylic acids comprises at least one carboxylic acid selected from the group consisting of fumaric acid and lactic acid.
EX10: A liquid nicotine formulation according to any one of examples EX1 to EX4 or EX7 wherein the plurality of carboxylic acids comprises at least one carboxylic acid selected from the group consisting of acetic acid and lactic acid.
EX11: A liquid nicotine formulation according to any one of examples EX1 to EX4 or EX7 wherein the plurality of carboxylic acids comprises lactic acid.
EX12: A cartridge for an aerosol-generating system, the cartridge comprising: a liquid storage portion comprising a liquid nicotine formulation according to any one of examples EX1 to
EX11; and an atomiser in fluid communication with the liquid storage portion, wherein the atomiser is configured to vaporise the liquid nicotine formulation to generate an aerosol.
EX13: A cartridge for an aerosol-generating system, the cartridge comprising: a liquid storage portion comprising a liquid nicotine formulation, wherein the liquid nicotine formulation comprises nicotine, a liquid carrier, and at least one carboxylic acid selected from the group consisting of benzoic acid and fumaric acid; and a fluid permeable heating element in fluid communication with the liquid storage portion, wherein the fluid permeable heating element comprises an electrically conductive mesh configured to vaporise the liquid nicotine formulation to generate an aerosol.
EX14: A cartridge for an aerosol-generating system, the cartridge comprising: a liquid storage portion comprising a liquid nicotine formulation according to any one of examples EX1 to
EX11; and a fluid permeable heating element in fluid communication with the liquid storage portion, wherein the fluid permeable heating element comprises an electrically conductive mesh configured to vaporise the liquid nicotine formulation to generate an aerosol.
EX15: A liquid nicotine formulation according to any one of examples EX1 to EX11 or a cartridge according to any one of examples EX12 to EX14 wherein the liquid nicotine formulation has a total carboxylic acid content of greater than or equal to about 0.1 percent by weight.
EX16: A liquid nicotine formulation according to any one of examples EX1 to EX11 or a cartridge according to any one of examples EX12 to EX14 wherein the liquid nicotine formulation has a total carboxylic acid content of greater than or equal to about 0.5 percent by weight.
EX17: A liquid nicotine formulation according to any one of examples EX1 to EX11 or a cartridge according to any one of examples EX12 to EX14 wherein the liquid nicotine formulation has a total carboxylic acid content of greater than or equal to about 1 percent by weight.
EX18: A liquid nicotine formulation according to any one of examples EX1 to EX11 or a cartridge according to any one of examples EX12 to EX14 wherein the liquid nicotine formulation has a total carboxylic acid content of or greater than or equal to about 1.5 percent by weight.
EX19: A liquid nicotine formulation according to any one of examples EX1 to EX11 or a cartridge according to any one of examples EX12 to EX14 wherein the liquid nicotine formulation has a total carboxylic acid content of or greater than or equal to about 2 percent by weight.
EX20: A liquid nicotine formulation according to any one of examples EX1 to EX11 or a cartridge according to any one of examples EX12 to EX14 wherein the liquid nicotine formulation has a total carboxylic acid content of or greater than or equal to about 2.5 percent by weight.
EX21: A liquid nicotine formulation according to any one of examples EX1 to EX11 or a cartridge according to any one of examples EX12 to EX14 wherein the liquid nicotine formulation has a total carboxylic acid content of less than or equal to about 7 percent by weight.
EX22: A liquid nicotine formulation according to any one of examples EX1 to EX11 or a cartridge according to any one of examples EX12 to EX14 wherein the liquid nicotine formulation has a total carboxylic acid content of less than or equal to about 6 percent by weight.
EX23: A liquid nicotine formulation according to any one of examples EX1 to EX11 or a cartridge according to any one of examples EX12 to EX14 wherein the liquid nicotine formulation has a total carboxylic acid content of less than or equal to about 5 percent by weight.
EX24: A liquid nicotine formulation according to any one of examples EX1 to EX11 or a cartridge according to any one of examples EX12 to EX14 wherein the liquid nicotine formulation has a total carboxylic acid content of less than or equal to about 4 percent by weight.
EX25: A liquid nicotine formulation according to any one of examples EX1 to EX11 or a cartridge according to any one of examples EX12 to EX14 wherein the liquid nicotine formulation has a total carboxylic acid content of or less than or equal to about 3 percent by weight.
EX26: A liquid nicotine formulation according to any one of examples EX1 to EX11 or a cartridge according to any one of examples EX12 to EX14 wherein the liquid nicotine formulation has a total carboxylic acid content of between about 0.1 percent by weight and about 7 percent by weight.
EX27: A liquid nicotine formulation according to any one of examples EX1 to EX11 or a cartridge according to any one of examples EX12 to EX14 wherein the liquid nicotine formulation has a total carboxylic acid content of between about 0.1 percent by weight and about 6 percent by weight.
EX28: A liquid nicotine formulation according to any one of examples EX1 to EX11 or a cartridge according to any one of examples EX12 to EX14 wherein the liquid nicotine formulation has a total carboxylic acid content of between about 0.1 percent by weight and about 5 percent by weight.
EX29: A liquid nicotine formulation according to any one of examples EX1 to EX11 or a cartridge according to any one of examples EX12 to EX14 wherein the liquid nicotine formulation has a total carboxylic acid content of between about 0.1 percent by weight and about 4 percent by weight.
EX30: A liquid nicotine formulation according to any one of examples EX1 to EX11 or a cartridge according to any one of examples EX12 to EX14 wherein the liquid nicotine formulation has a total carboxylic acid content of between about 0.1 percent by weight and about 3 percent by weight.
EX31: A liquid nicotine formulation according to any one of examples EX1 to EX11 or a cartridge according to any one of examples EX12 to EX14 wherein the liquid nicotine formulation has a total carboxylic acid content of between about 0.5 percent by weight and about 7 percent by weight.
EX32: A liquid nicotine formulation according to any one of examples EX1 to EX11 or a cartridge according to any one of examples EX12 to EX14 wherein the liquid nicotine formulation has a total carboxylic acid content of between about 0.5 percent by weight and about 6 percent by weight.
EX33: A liquid nicotine formulation according to any one of examples EX1 to EX11 or a cartridge according to any one of examples EX12 to EX14 wherein the liquid nicotine formulation has a total carboxylic acid content of between about 0.5 percent by weight and about 5 percent by weight.
EX34: A liquid nicotine formulation according to any one of examples EX1 to EX11 or a cartridge according to any one of examples EX12 to EX14 wherein the liquid nicotine formulation has a total carboxylic acid content of between about 0.5 percent by weight and about 4 percent by weight.
EX35: A liquid nicotine formulation according to any one of examples EX1 to EX11 or a cartridge according to any one of examples EX12 to EX14 wherein the liquid nicotine formulation has a total carboxylic acid content of between about 0.5 percent by weight and about 3 percent by weight.
EX36: A liquid nicotine formulation according to any one of examples EX1 to EX11 or a cartridge according to any one of examples EX12 to EX14 wherein the liquid nicotine formulation has a total carboxylic acid content of between about 1 percent by weight and about 7 percent by weight.
EX37: A liquid nicotine formulation according to any one of examples EX1 to EX11 or a cartridge according to any one of examples EX12 to EX14 wherein the liquid nicotine formulation has a total carboxylic acid content of between about 1 percent by weight and about 6 percent by weight.
EX38: A liquid nicotine formulation according to any one of examples EX1 to EX11 or a cartridge according to any one of examples EX12 to EX14 wherein the liquid nicotine formulation has a total carboxylic acid content of between about 1 percent by weight and about 5 percent by weight.
EX39 A liquid nicotine formulation according to any one of examples EX1 to EX11 or a cartridge according to any one of examples EX12 to EX14 wherein the liquid nicotine formulation has a total carboxylic acid content of between about 1 percent by weight and about 4 percent by weight.
EX40: A liquid nicotine formulation according to any one of examples EX1 to EX11 or a cartridge according to any one of examples EX12 to EX14 wherein the liquid nicotine formulation has a total carboxylic acid content of between about 1 percent by weight and about 3 percent by weight.
EX41: A liquid nicotine formulation according to any one of examples EX1 to EX11 or a cartridge according to any one of examples EX12 to EX14 wherein the liquid nicotine formulation has a total carboxylic acid content of between about 1.5 percent by weight and about 7 percent by weight.
EX42: A liquid nicotine formulation according to any one of examples EX1 to EX11 or a cartridge according to any one of examples EX12 to EX14 wherein the liquid nicotine formulation has a total carboxylic acid content of between about 1.5 percent by weight and about 6 percent by weight.
EX43: A liquid nicotine formulation according to any one of examples EX1 to EX11 or a cartridge according to any one of examples EX12 to EX14 wherein the liquid nicotine formulation has a total carboxylic acid content of between about 1.5 percent by weight and about 5 percent by weight.
EX44: A liquid nicotine formulation according to any one of examples EX1 to EX11 or a cartridge according to any one of examples EX12 to EX14 wherein the liquid nicotine formulation has a total carboxylic acid content of between about 1.5 percent by weight and about 4 percent by weight.
EX45: A liquid nicotine formulation according to any one of examples EX1 to EX11 or a cartridge according to any one of examples EX12 to EX14 wherein the liquid nicotine formulation has a total carboxylic acid content of between about 1.5 percent by weight and about 3 percent by weight.
EX46: A liquid nicotine formulation according to any one of examples EX1 to EX11 or a cartridge according to any one of examples EX12 to EX14 wherein the liquid nicotine formulation has a total carboxylic acid content of between about 2 percent by weight and about 7 percent by weight.
EX47: A liquid nicotine formulation according to any one of examples EX1 to EX11 or a cartridge according to any one of examples EX12 to EX14 wherein the liquid nicotine formulation has a total carboxylic acid content of between about 2 percent by weight and about 6 percent by weight.
EX48: A liquid nicotine formulation according to any one of examples EX1 to EX11 or a cartridge according to any one of examples EX12 to EX14 wherein the liquid nicotine formulation has a total carboxylic acid content of between about 2 percent by weight and about 5 percent by weight.
EX49: A liquid nicotine formulation according to any one of examples EX1 to EX11 or a cartridge according to any one of examples EX12 to EX14 wherein the liquid nicotine formulation has a total carboxylic acid content of between about 2 percent by weight and about 4 percent by weight.
EX50: A liquid nicotine formulation according to any one of examples EX1 to EX11 or a cartridge according to any one of examples EX12 to EX14 wherein the liquid nicotine formulation has a total carboxylic acid content of between about 2 percent by weight and about 3 percent by weight.
EX51: A liquid nicotine formulation according to any one of examples EX1 to EX11 or a cartridge according to any one of examples EX12 to EX14 wherein the liquid nicotine formulation has a total carboxylic acid content of between about 2.5 percent by weight and about 7 percent by weight.
EX52: A liquid nicotine formulation according to any one of examples EX1 to EX11 or a cartridge according to any one of examples EX12 to EX14 wherein the liquid nicotine formulation has a total carboxylic acid content of between about 2.5 percent by weight and about 6 percent by weight.
EX53: A liquid nicotine formulation according to any one of examples EX1 to EX11 or a cartridge according to any one of examples EX12 to EX14 wherein the liquid nicotine formulation has a total carboxylic acid content of between about 2.5 percent by weight and about 5 percent by weight.
EX54: A liquid nicotine formulation according to any one of examples EX1 to EX11 or a cartridge according to any one of examples EX12 to EX14 wherein the liquid nicotine formulation has a total carboxylic acid content of between about 2.5 percent by weight and about 4 percent by weight.
EX55: A liquid nicotine formulation according to any one of examples EX1 to EX11 or a cartridge according to any one of examples EX12 to EX14 wherein the liquid nicotine formulation has a total carboxylic acid content of between about 2.5 percent by weight and about 3 percent by weight.
EX56: A liquid nicotine formulation according to any one of examples EX1 to EX11 and EX15 to EX55 or a cartridge according to any one of examples EX12 to EX55 wherein the molar ratio of total carboxylic acid to nicotine in the liquid nicotine formulation is greater than or equal to about 0.65:1.
EX57: A liquid nicotine formulation according to any one of examples EX1 to EX11 and EX15 to EX55 or a cartridge according to any one of examples EX12 to EX55 wherein the molar ratio of total carboxylic acid to nicotine in the liquid nicotine formulation is greater than or equal to about 0.7:1.
EX58: A liquid nicotine formulation according to any one of examples EX1 to EX11 and EX15 to EX55 or a cartridge according to any one of examples EX12 to EX55 wherein the molar ratio of total carboxylic acid to nicotine in the liquid nicotine formulation is greater than or equal to about 0.75:1.
EX59: A liquid nicotine formulation according to any one of examples EX1 to EX11 and EX15 to EX55 or a cartridge according to any one of examples EX12 to EX55 wherein the molar ratio of total carboxylic acid to nicotine in the liquid nicotine formulation is less than or equal to about 1.4:1.
EX60: A liquid nicotine formulation according to any one of examples EX1 to EX11 and EX15 to EX55 or a cartridge according to any one of examples EX12 to EX55 wherein the molar ratio of total carboxylic acid to nicotine in the liquid nicotine formulation is less than or equal to about 1.3:1.
EX61: A liquid nicotine formulation according to any one of examples EX1 to EX11 and EX15 to EX55 or a cartridge according to any one of examples EX12 to EX55 wherein the molar ratio of total carboxylic acid to nicotine in the liquid nicotine formulation is less than or equal to about 1.2:1.
EX62: A liquid nicotine formulation according to any one of examples EX1 to EX11 and EX15 to EX55 or a cartridge according to any one of examples EX12 to EX55 wherein the molar ratio of total carboxylic acid to nicotine in the liquid nicotine formulation is between about 0.65:1 and about 1.4:1.
EX63: A liquid nicotine formulation according to any one of examples EX1 to EX11 and EX15 to EX55 or a cartridge according to any one of examples EX12 to EX55 wherein the molar ratio of total carboxylic acid to nicotine in the liquid nicotine formulation is between about 0.65:1 and about 1.3:1.
EX64: A liquid nicotine formulation according to any one of examples EX1 to EX11 and EX15 to EX55 or a cartridge according to any one of examples EX12 to EX55 wherein the molar ratio of total carboxylic acid to nicotine in the liquid nicotine formulation is between about 0.65:1 and about 1.2:1.
EX65: A liquid nicotine formulation according to any one of examples EX1 to EX11 and EX15 to EX55 or a cartridge according to any one of examples EX12 to EX55 wherein the molar ratio of total carboxylic acid to nicotine in the liquid nicotine formulation is between about 0.7:1 and about 1.4:1.
EX66: A liquid nicotine formulation according to any one of examples EX1 to EX11 and EX15 to EX55 or a cartridge according to any one of examples EX12 to EX55 wherein the molar ratio of total carboxylic acid to nicotine in the liquid nicotine formulation is between about 0.7:1 and about 1.3:1.
EX67: A liquid nicotine formulation according to any one of examples EX1 to EX11 and EX15 to EX55 or a cartridge according to any one of examples EX12 to EX55 wherein the molar ratio of total carboxylic acid to nicotine in the liquid nicotine formulation is between about 0.7:1 and about 1.2:1.
EX68: A liquid nicotine formulation according to any one of examples EX1 to EX11 and EX156 to EX55 or a cartridge according to any one of examples EX12 to EX55 wherein the molar ratio of total carboxylic acid to nicotine in the liquid nicotine formulation is between about 0.75:1 and about 1.4:1.
EX69: A liquid nicotine formulation according to any one of examples EX1 to EX11 and EX15 to EX55 or a cartridge according to any one of examples EX12 to EX55 wherein the molar ratio of total carboxylic acid to nicotine in the liquid nicotine formulation is between about 0.75:1 and about 1.3:1.
EX70: A liquid nicotine formulation according to any one of examples EX1 to EX11 and EX15 to EX55 or a cartridge according to any one of examples EX12 to EX55 wherein the molar ratio of total carboxylic acid to nicotine in the liquid nicotine formulation is between about 0.75:1 and about 1.2:1.
EX71: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is greater than or equal to about 0.2:1.
EX72: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is greater than or equal to about 0.3:1.
EX73: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is greater than or equal to about 0.4:1.
EX74: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is greater than or equal to about 0.5:1.
EX75: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is less than or equal to about 1:1.
EX76: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is less than or equal to about 0.9:1.
EX77: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is less than or equal to about 0.8:1
EX78: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is less than or equal to about 0.7:1.
EX79: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.2:1 and about 1:1.
EX80: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.2:1 and about 0.9:1.
EX81: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.2:1 and about 0.8:1.
EX82: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.2:1 and about 0.7:1.
EX83: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.3:1 and about 1:1.
EX84: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.3:1 and about 0.9:1.
EX85: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.3:1 and about 0.8:1.
EX86: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.3:1 and about 0.7:1
EX87: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.4:1 and about 1:1.
EX88: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.4:1 and about 0.9:1.
EX89: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.4:1 and about 0.8:1.
EX90: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.4:1 and about 0.7:1.
EX91: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.5:1 and about 1:1.
EX92: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.5:1 and about 0.9:1.
EX93: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.5:1 and about 0.8:1.
EX94: A liquid nicotine formulation according to any one of examples EX1 to EX11 and EX15 to EX70 or a cartridge according to any one of examples EX12 to EX70 wherein the molar ratio of benzoic acid to nicotine in the liquid nicotine formulation is between about 0.5:1 and about 0.7:1.
EX95: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is greater than or equal to about 0.1:1.
EX95: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is greater than or equal to about 0.2:1.
EX97: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is greater than or equal to about 0.3:1.
EX98: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is greater than or equal to about 0.4:1.
EX99: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is greater than or equal to about 0.5:1.
EX100: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is less than or equal to about 0.95:1.
EX101: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is less than or equal to about 0.9:1.
EX102: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is less than or equal to about 0.85:1.
EX103: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is less than or equal to about 0.8:1.
EX104: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.1:1 and about 0.95:1.
EX105: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.1:1 and about 0.9:1.
EX106: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.1:1 and about 0.85:1.
EX107: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.1:1 and about 0.8:1.
EX108: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.2:1 and about 0.95:1.
EX109: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.2:1 and about 0.9:1.
EX110: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.2:1 and about 0.85:1.
EX111: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.2:1 and about 0.8:1.
EX112: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.3:1 and about 0.95:1.
EX113: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.3:1 and about 0.9:1.
EX114: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.3:1 and about 0.85:1.
EX115: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.3:1 and about 0.8:1.
EX116: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.4:1 and about 0.95:1.
EX117: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.4:1 and about 0.9:1.
EX118: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.4:1 and about 0.85:1.
EX119: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.4:1 and about 0.8:1.
EX120: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.5:1 and about 0.95:1.
EX121: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.5:1 and about 0.9:1.
EX122: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.5:1 and about 0.85:1.
EX123: A liquid nicotine formulation according to any one of examples EX1 to EX11 and EX15 to EX94 or a cartridge according to any one of examples EX12 to EX94 wherein the molar ratio of benzoic acid to total carboxylic acid in the liquid nicotine formulation is between about 0.5:1 and about 0.8:1.
EX124: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is greater than or equal to about 0.05:1.
EX125: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is greater than or equal to about 0.1:1.
EX126: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is greater than or equal to about 0.15:1.
EX127: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is greater than or equal to about 0.2:1.
EX128: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is less than or equal to about 0.9:1.
EX129: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is less than or equal to about 0.8:1.
EX130: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is less than or equal to about 0.7:1.
EX131: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is less than or equal to about 0.6:1.
EX132: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.05:1 and about 0.9:1.
EX133: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.05:1 and about 0.8:1.
EX134: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.05:1 and about 0.7:1.
EX135: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.05:1 and about 0.6:1.
EX136: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.1:1 and about 0.9:1.
EX137: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.1:1 and about 0.8:1.
EX138: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.1:1 and about 0.7:1.
EX139: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.1:1 and about 0.6:1.
EX140: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.15:1 and about 0.9:1.
EX141: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.15:1 and about 0.8:1.
EX142: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.15:1 and about 0.7:1.
EX143: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.15:1 and about 0.6:1.
EX144: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.2:1 and about 0.9:1.
EX145: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.2:1 and about 0.8:1.
EX146: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.2:1 and about 0.7:1.
EX147: A liquid nicotine formulation according to any one of examples EX1 to EX11 and EX15 to EX123 or a cartridge according to any one of examples EX12 to EX123 wherein the molar ratio of fumaric acid to nicotine in the liquid nicotine formulation is between about 0.2:1 and about 0.6:1.
EX148: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is greater than or equal to about 0.05:1.
EX149: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is greater than or equal to about 0.1:1.
EX150: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is greater than or equal to about 0.15:1.
EX151: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is greater than or equal to about 0.2:1.
EX152: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is less than or equal to about 0.95:1.
EX153: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is less than or equal to about 0.8:1.
EX154: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is less than or equal to about 0.7:1.
EX155: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is less than or equal to about 0.6:1.
EX156: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.05:1 and about 0.95:1.
EX157: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.05:1 and about 0.8:1.
EX158: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.05:1 and about 0.7:1.
EX159: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.05:1 and about 0.6:1.
EX160: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.1:1 and about 0.95:1.
EX161: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.1:1 and about 0.8:1.
EX162: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.1:1 and about 0.7:1.
EX163: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.1:1 and about 0.6:1.
EX164: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.15:1 and about 0.95:1.
EX165: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.15:1 and about 0.8:1.
EX166: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.15:1 and about 0.7:1.
EX167: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.15:1 and about 0.6:1.
EX168: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.2:1 and about 0.95:1.
EX169: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.2:1 and about 0.8:1.
EX170: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.2:1 and about 0.7:1.
EX171: A liquid nicotine formulation according to any one of examples EX1 to EX11 and EX15 to EX147 or a cartridge according to any one of examples EX12 to EX147 wherein the molar ratio of fumaric acid to total carboxylic acid in the liquid nicotine formulation is between about 0.2:1 and about 0.6:1.
EX172: A liquid nicotine formulation according to any one of examples EX1 to EX11 and EX15 to EX171 or a cartridge according to any one of examples EX12 to EX171 wherein the liquid nicotine formulation has a nicotine content of greater than or equal to about 0.5 percent by weight.
EX173: A liquid nicotine formulation according to any one of examples EX1 to EX11 and EX15 to EX171 or a cartridge according to any one of examples EX12 to EX171 wherein the liquid nicotine formulation has a nicotine content of greater than or equal to about 1 percent by weight.
EX174: A liquid nicotine formulation according to any one of examples EX1 to EX11 and EX15 to EX171 or a cartridge according to any one of examples EX12 to EX171 wherein the liquid nicotine formulation has a nicotine content of or greater than or equal to about 1.5 percent by weight.
EX175: A liquid nicotine formulation according to any one of examples EX1 to EX11 and EX15 to EX171 or a cartridge according to any one of examples EX12 to EX171 wherein the liquid nicotine formulation has a nicotine content of greater than or equal to about 2 percent by weight.
EX176: A liquid nicotine formulation according to any one of examples EX1 to EX11 and EX15 to EX171 or a cartridge according to any one of examples EX12 to EX171 wherein the liquid nicotine formulation has a nicotine content of or greater than or equal to about 2.5 percent by weight.
EX177: A liquid nicotine formulation according to any one of examples EX1 to EX11 and EX15 to EX171 or a cartridge according to any one of examples EX12 to EX171 wherein the liquid nicotine formulation has a nicotine content of greater than or equal to about 3 percent by weight.
EX178: A liquid nicotine formulation according to any one of examples EX1 to EX11 and EX15 to EX171 or a cartridge according to any one of examples EX12 to EX171 wherein the liquid nicotine formulation has a nicotine content of or greater than or equal to about 3.5 percent by weight.
EX179: A liquid nicotine formulation according to any one of examples EX1 to EX11 and EX15 to EX171 or a cartridge according to any one of examples EX12 to EX171 wherein the liquid nicotine formulation has a nicotine content of less than or equal to about 8 percent by weight.
EX180: A liquid nicotine formulation according to any one of examples EX1 to EX11 and EX15 to EX171 or a cartridge according to any one of examples EX12 to EX171 wherein the liquid nicotine formulation has a nicotine content of less than or equal to about 7 percent by weight.
EX181: A liquid nicotine formulation according to any one of examples EX1 to EX11 and EX15 to EX171 or a cartridge according to any one of examples EX12 to EX171 wherein the liquid nicotine formulation has a nicotine content of less than or equal to about 6 percent by weight.
EX182: A liquid nicotine formulation according to any one of examples EX1 to EX11 and EX15 to EX171 or a cartridge according to any one of examples EX12 to EX171 wherein the liquid nicotine formulation has a nicotine content of less than or equal to about 5 percent by weight.
EX183: A liquid nicotine formulation according to any one of examples EX1 to EX11 and EX15 to EX171 or a cartridge according to any one of examples EX12 to EX171 wherein the liquid nicotine formulation has a nicotine content of or less than or equal to about 4 percent by weight.
EX184: A liquid nicotine formulation according to any one of examples EX1 to EX11 and EX15 to EX171 or a cartridge according to any one of examples EX12 to EX171 wherein the liquid nicotine formulation has a nicotine content of between about 0.5 percent by weight and about 8 percent by weight.
EX185: A liquid nicotine formulation according to any one of examples EX1 to EX11 and EX15 to EX171 or a cartridge according to any one of examples EX12 to EX171 wherein the liquid nicotine formulation has a nicotine content of between about 0.5 percent by weight and about 7 percent by weight.
EX186: A liquid nicotine formulation according to any one of examples EX1 to EX11 and EX15 to EX171 or a cartridge according to any one of examples EX12 to EX171 wherein the liquid nicotine formulation has a nicotine content of between about 0.5 percent by weight and about 6 percent by weight.
EX187: A liquid nicotine formulation according to any one of examples EX1 to EX11 and EX15 to EX171 or a cartridge according to any one of examples EX12 to EX171 wherein the liquid nicotine formulation has a nicotine content of between about 0.5 percent by weight and about 5 percent by weight.
EX188: A liquid nicotine formulation according to any one of examples EX1 to EX11 and EX15 to EX171 or a cartridge according to any one of examples EX12 to EX171 wherein the liquid nicotine formulation has a nicotine content of between about 0.5 percent by weight and about 4 percent by weight.
EX189: A liquid nicotine formulation according to any one of examples EX1 to EX11 and EX15 to EX171 or a cartridge according to any one of examples EX12 to EX171 wherein the liquid nicotine formulation has a nicotine content of between about 1 percent by weight and about 8 percent by weight.
EX190: A liquid nicotine formulation according to any one of examples EX1 to EX11 and EX15 to EX171 or a cartridge according to any one of examples EX12 to EX171 wherein the liquid nicotine formulation has a nicotine content of between about 1 percent by weight and about 7 percent by weight.
EX191: A liquid nicotine formulation according to any one of examples EX1 to EX11 and EX15 to EX171 or a cartridge according to any one of examples EX12 to EX171 wherein the liquid nicotine formulation has a nicotine content of between about 1 percent by weight and about 6 percent by weight.
EX192: A liquid nicotine formulation according to any one of examples EX1 to EX11 and EX15 to EX171 or a cartridge according to any one of examples EX12 to EX171 wherein the liquid nicotine formulation has a nicotine content of between about 1 percent by weight and about 5 percent by weight.
EX193: A liquid nicotine formulation according to any one of examples EX1 to EX11 and EX15 to EX171 or a cartridge according to any one of examples EX12 to EX171 wherein the liquid nicotine formulation has a nicotine content of between about 1 percent by weight and about 4 percent by weight.
EX194: A liquid nicotine formulation according to any one of examples EX1 to EX11 and EX15 to EX171 or a cartridge according to any one of examples EX12 to EX171 wherein the liquid nicotine formulation has a nicotine content of between about 1.5 percent by weight and about 8 percent by weight.
EX195: A liquid nicotine formulation according to any one of examples EX1 to EX11 and EX15 to EX171 or a cartridge according to any one of examples EX12 to EX171 wherein the liquid nicotine formulation has a nicotine content of between about 1.5 percent by weight and about 7 percent by weight.
EX196: A liquid nicotine formulation according to any one of examples EX1 to EX11 and EX15 to EX171 or a cartridge according to any one of examples EX12 to EX171 wherein the liquid nicotine formulation has a nicotine content of between about 1.5 percent by weight and about 6 percent by weight.
EX197: A liquid nicotine formulation according to any one of examples EX1 to EX11 and EX15 to EX171 or a cartridge according to any one of examples EX12 to EX171 wherein the liquid nicotine formulation has a nicotine content of between about 1.5 percent by weight and about 5 percent by weight.
EX198: A liquid nicotine formulation according to any one of examples EX1 to EX11 and EX15 to EX171 or a cartridge according to any one of examples EX12 to EX171 wherein the liquid nicotine formulation has a nicotine content of between about 1.5 percent by weight and about 4 percent by weight.
EX199: A liquid nicotine formulation according to any one of examples EX1 to EX11 and EX15 to EX171 or a cartridge according to any one of examples EX12 to EX171 wherein the liquid nicotine formulation has a nicotine content of between about 2 percent by weight and about 8 percent by weight.
EX200: A liquid nicotine formulation according to any one of examples EX1 to EX11 and EX15 to EX171 or a cartridge according to any one of examples EX12 to EX171 wherein the liquid nicotine formulation has a nicotine content of between about 2 percent by weight and about 7 percent by weight.
EX201: A liquid nicotine formulation according to any one of examples EX1 to EX11 and EX15 to EX171 or a cartridge according to any one of examples EX12 to EX171 wherein the liquid nicotine formulation has a nicotine content of between about 2 percent by weight and about 6 percent by weight.
EX202: A liquid nicotine formulation according to any one of examples EX1 to EX11 and EX15 to EX171 or a cartridge according to any one of examples EX12 to EX171 wherein the liquid nicotine formulation has a nicotine content of between about 2 percent by weight and about 5 percent by weight.
EX203: A liquid nicotine formulation according to any one of examples EX1 to EX11 and EX15 to EX171 or a cartridge according to any one of examples EX12 to EX171 wherein the liquid nicotine formulation has a nicotine content of between about 2 percent by weight and about 4 percent by weight.
EX204: A liquid nicotine formulation according to any one of examples EX1 to EX11 and EX15 to EX171 or a cartridge according to any one of examples EX12 to EX171 wherein the liquid nicotine formulation has a nicotine content of between about 2.5 percent by weight and about 8 percent by weight.
EX205: A liquid nicotine formulation according to any one of examples EX1 to EX11 and EX15 to EX171 or a cartridge according to any one of examples EX12 to EX171 wherein the liquid nicotine formulation has a nicotine content of between about 2.5 percent by weight and about 7 percent by weight.
EX206: A liquid nicotine formulation according to any one of examples EX1 to EX11 and EX15 to EX171 or a cartridge according to any one of examples EX12 to EX171 wherein the liquid nicotine formulation has a nicotine content of between about 2.5 percent by weight and about 6 percent by weight.
EX207: A liquid nicotine formulation according to any one of examples EX1 to EX11 and EX15 to EX171 or a cartridge according to any one of examples EX12 to EX171 wherein the liquid nicotine formulation has a nicotine content of between about 2.5 percent by weight and about 5 percent by weight.
EX208: A liquid nicotine formulation according to any one of examples EX1 to EX11 and EX15 to EX171 or a cartridge according to any one of examples EX12 to EX171 wherein the liquid nicotine formulation has a nicotine content of between about 2.5 percent by weight and about 4 percent by weight.
EX209: A liquid nicotine formulation according to any one of examples EX1 to EX11 and EX15 to EX171 or a cartridge according to any one of examples EX12 to EX171 wherein the liquid nicotine formulation has a nicotine content of between about 3 percent by weight and about 8 percent by weight.
EX210: A liquid nicotine formulation according to any one of examples EX1 to EX11 and EX15 to EX171 or a cartridge according to any one of examples EX12 to EX171 wherein the liquid nicotine formulation has a nicotine content of between about 3 percent by weight and about 7 percent by weight.
EX211: A liquid nicotine formulation according to any one of examples EX1 to EX11 and EX15 to EX171 or a cartridge according to any one of examples EX12 to EX171 wherein the liquid nicotine formulation has a nicotine content of between about 3 percent by weight and about 6 percent by weight.
EX212: A liquid nicotine formulation according to any one of examples EX1 to EX11 and EX15 to EX171 or a cartridge according to any one of examples EX12 to EX171 wherein the liquid nicotine formulation has a nicotine content of between about 3 percent by weight and about 5 percent by weight.
EX213: A liquid nicotine formulation according to any one of examples EX1 to EX11 and EX15 to EX171 or a cartridge according to any one of examples EX12 to EX171 wherein the liquid nicotine formulation has a nicotine content of between about 3 percent by weight and about 4 percent by weight.
EX214: A liquid nicotine formulation according to any one of examples EX1 to EX11 and EX15 to EX171 or a cartridge according to any one of examples EX12 to EX171 wherein the liquid nicotine formulation has a nicotine content of between about 3.5 percent by weight and about 8 percent by weight.
EX215: A liquid nicotine formulation according to any one of examples EX1 to EX11 and EX15 to EX171 or a cartridge according to any one of examples EX12 to EX171 wherein the liquid nicotine formulation has a nicotine content of between about 3.5 percent by weight and about 7 percent by weight.
EX216: A liquid nicotine formulation according to any one of examples EX1 to EX11 and EX15 to EX171 or a cartridge according to any one of examples EX12 to EX171 wherein the liquid nicotine formulation has a nicotine content of between about 3.5 percent by weight and about 6 percent by weight.
EX217: A liquid nicotine formulation according to any one of examples EX1 to EX11 and EX15 to EX171 or a cartridge according to any one of examples EX12 to EX171 wherein the liquid nicotine formulation has a nicotine content of between about 3.5 percent by weight and about 5 percent by weight.
EX218: A liquid nicotine formulation according to any one of examples EX1 to EX11 and EX15 to EX171 or a cartridge according to any one of examples EX12 to EX171 wherein the liquid nicotine formulation has a nicotine content of between about 3.5 percent by weight and about 4 percent by weight.
EX219: A liquid nicotine formulation according to any one of examples EX1 to EX11 and EX15 to EX218 or a cartridge according to any one of examples EX12 to EX218 wherein the liquid nicotine formulation has a liquid carrier content of greater than or equal to about 80 percent by weight.
EX220: A liquid nicotine formulation according to any one of examples EX1 to EX11 and EX15 to EX218 or a cartridge according to any one of examples EX12 to EX218 wherein the liquid nicotine formulation has a liquid carrier content of greater than or equal to about 85 percent by weight.
EX221: A liquid nicotine formulation according to any one of examples EX1 to EX11 and EX15 to EX218 or a cartridge according to any one of examples EX12 to EX218 wherein the liquid nicotine formulation has a liquid carrier content of greater than or equal to about 90 percent by weight.
EX222: A liquid nicotine formulation according to any one of examples EX1 to EX11 and EX15 to EX218 or a cartridge according to any one of examples EX12 to EX218 wherein the liquid nicotine formulation has a liquid carrier content of less than or equal to about 99 percent by weight.
EX223: A liquid nicotine formulation according to any one of examples EX1 to EX11 and EX15 to EX218 or a cartridge according to any one of examples EX12 to EX218 wherein the liquid nicotine formulation has a liquid carrier content of less than or equal to about 97 percent by weight.
EX224: A liquid nicotine formulation according to any one of examples EX1 to EX11 and EX15 to EX218 or a cartridge according to any one of examples EX12 to EX218 wherein the liquid nicotine formulation has a liquid carrier content of less than or equal to about 95 percent by weight.
EX225: A liquid nicotine formulation according to any one of examples EX1 to EX11 and EX15 to EX218 or a cartridge according to any one of examples EX12 to EX218 wherein the liquid nicotine formulation has a liquid carrier content of between about 80 percent by weight and about 99 percent by weight.
EX226: A liquid nicotine formulation according to any one of examples EX1 to EX11 and EX15 to EX218 or a cartridge according to any one of examples EX12 to EX218 wherein the liquid nicotine formulation has a liquid carrier content of between about 80 percent by weight and about 97 percent by weight.
EX227: A liquid nicotine formulation according to any one of examples EX1 to EX11 and EX15 to EX218 or a cartridge according to any one of examples EX12 to EX218 wherein the liquid nicotine formulation has a liquid carrier content of between about 80 percent by weight and about 95 percent by weight.
EX228: A liquid nicotine formulation according to any one of examples EX1 to EX11 and EX15 to EX218 or a cartridge according to any one of examples EX12 to EX218 wherein the liquid nicotine formulation has a liquid carrier content of between about 85 percent by weight and about 99 percent by weight.
EX229: A liquid nicotine formulation according to any one of examples EX1 to EX11 and EX15 to EX218 or a cartridge according to any one of examples EX12 to EX218 wherein the liquid nicotine formulation has a liquid carrier content of between about 85 percent by weight and about 97 percent by weight.
EX230: A liquid nicotine formulation according to any one of examples EX1 to EX11 and EX15 to EX218 or a cartridge according to any one of examples EX12 to EX218 wherein the liquid nicotine formulation has a liquid carrier content of between about 85 percent by weight and about 95 percent by weight.
EX231: A liquid nicotine formulation according to any one of examples EX1 to EX11 and EX15 to EX218 or a cartridge according to any one of examples EX12 to EX218 wherein the liquid nicotine formulation has a liquid carrier content of between about 90 percent by weight and about 99 percent by weight.
EX232: A liquid nicotine formulation according to any one of examples EX1 to EX11 and EX15 to EX218 or a cartridge according to any one of examples EX12 to EX218 wherein the liquid nicotine formulation has a liquid carrier content of between about 90 percent by weight and about 97 percent by weight.
EX233: A liquid nicotine formulation according to any one of examples EX1 to EX11 and EX15 to EX218 or a cartridge according to any one of examples EX12 to EX218 wherein the liquid nicotine formulation has a liquid carrier content of between about 90 percent by weight and about 95 percent by weight.
EX234: A liquid nicotine formulation according to any one of examples EX1 to EX11 and EX15 to EX233 or a cartridge according to any one of examples EX12 to EX233 wherein the liquid carrier comprises one or more medium chain triglycerides.
EX235: A liquid nicotine formulation according to any one of examples EX1 to EX11 and EX15 to EX234 or a cartridge according to any one of examples EX12 to EX234 wherein the liquid carrier comprises one or more polyhydric alcohols.
EX236: A liquid nicotine formulation according to EX235 or a cartridge according to EX235 wherein the liquid nicotine formulation has a polyhydric alcohol content of greater than or equal to about 60 percent by weight.
EX237: A liquid nicotine formulation according to EX235 or a cartridge according to EX235 wherein the liquid nicotine formulation has a polyhydric alcohol content of greater than or equal to about 70 percent by weight.
EX238: A liquid nicotine formulation according to EX235 or a cartridge according to EX235 wherein the liquid nicotine formulation has a polyhydric alcohol content of greater than or equal to about 80 percent by weight.
EX239: A liquid nicotine formulation according to EX235 or a cartridge according to EX235 wherein the liquid nicotine formulation has a polyhydric alcohol content of greater than or equal to about 85 percent by weight.
EX240: A liquid nicotine formulation according to EX235 or a cartridge according to EX235 wherein the liquid nicotine formulation has a polyhydric alcohol content of greater than or equal to about 90 percent by weight.
EX241: A liquid nicotine formulation according to EX235 or a cartridge according to EX235 wherein the liquid nicotine formulation has a polyhydric alcohol content of less than or equal to about 99 percent by weight.
EX242: A liquid nicotine formulation according to EX235 or a cartridge according to EX235 wherein the liquid nicotine formulation has a polyhydric alcohol content of less than or equal to about 97 percent by weight.
EX243: A liquid nicotine formulation according to EX235 or a cartridge according to EX235 wherein the liquid nicotine formulation has a polyhydric alcohol content of less than or equal to about 95 percent by weight.
EX244: A liquid nicotine formulation according to EX235 or a cartridge according to EX235 wherein the liquid nicotine formulation has a polyhydric alcohol content of between about 60 percent by weight and about 99 percent by weight.
EX245: A liquid nicotine formulation according to EX235 or a cartridge according to EX235 wherein the liquid nicotine formulation has a polyhydric alcohol content of between about 60 percent by weight and about 97 percent by weight.
EX246: A liquid nicotine formulation according to EX235 or a cartridge according to EX235 wherein the liquid nicotine formulation has a polyhydric alcohol content of between about 60 percent by weight and about 95 percent by weight.
EX247: A liquid nicotine formulation according to EX235 or a cartridge according to EX235 wherein the liquid nicotine formulation has a polyhydric alcohol content of between about 70 percent by weight and about 99 percent by weight.
EX248: A liquid nicotine formulation according to EX235 or a cartridge according to EX235 wherein the liquid nicotine formulation has a polyhydric alcohol content of between about 70 percent by weight and about 97 percent by weight.
EX249: A liquid nicotine formulation according to EX235 or a cartridge according to EX235 wherein the liquid nicotine formulation has a polyhydric alcohol content of between about 70 percent by weight and about 95 percent by weight.
EX250: A liquid nicotine formulation according to EX235 or a cartridge according to EX235 wherein the liquid nicotine formulation has a polyhydric alcohol content of between about 80 percent by weight and about 99 percent by weight.
EX251: A liquid nicotine formulation according to EX235 or a cartridge according to EX235 wherein the liquid nicotine formulation has a polyhydric alcohol content of between about 80 percent by weight and about 97 percent by weight.
EX252: A liquid nicotine formulation according to EX235 or a cartridge according to EX235 wherein the liquid nicotine formulation has a polyhydric alcohol content of between about 80 percent by weight and about 95 percent by weight.
EX253: A liquid nicotine formulation according to EX235 or a cartridge according to EX235 wherein the liquid nicotine formulation has a polyhydric alcohol content of between about 85 percent by weight and about 99 percent by weight.
EX254: A liquid nicotine formulation according to EX235 or a cartridge according to EX235 wherein the liquid nicotine formulation has a polyhydric alcohol content of between about 85 percent by weight and about 97 percent by weight.
EX255: A liquid nicotine formulation according to EX235 or a cartridge according to EX235 wherein the liquid nicotine formulation has a polyhydric alcohol content of between about 85 percent by weight and about 95 percent by weight.
EX256: A liquid nicotine formulation according to EX235 or a cartridge according to EX235 wherein the liquid nicotine formulation has a polyhydric alcohol content of between about 90 percent by weight and about 99 percent by weight.
EX257: A liquid nicotine formulation according to EX235 or a cartridge according to EX235 wherein the liquid nicotine formulation has a polyhydric alcohol content of between about 90 percent by weight and about 97 percent by weight.
EX258: A liquid nicotine formulation according to EX235 or a cartridge according to EX235 wherein the liquid nicotine formulation has a polyhydric alcohol content of between about 90 percent by weight and about 95 percent by weight.
EX259: A liquid nicotine formulation according to any one of examples EX1 to EX11 and EX15 to EX258 or a cartridge according to any one of examples EX12 to EX258 wherein the liquid carrier comprises one or more polyhydric alcohols selected from the group consisting of 1,3-propanediol, 1,3-butanediol, glycerine, propylene glycol, and triethylene glycol.
EX260: A liquid nicotine formulation according to any one of examples EX1 to EX11 and EX15 to EX259 or a cartridge according to any one of examples EX12 to EX259 wherein the liquid carrier comprises at least one polyhydric alcohol selected from the group consisting of glycerine and propylene glycol.
EX261: A liquid nicotine formulation according to any one of examples EX1 to EX11 and EX15 to EX259 or a cartridge according to any one of examples EX12 to EX259 wherein the liquid carrier at least one polyhydric alcohol selected from the group consisting of vegetable glycerine and propylene glycol.
EX262: A liquid nicotine formulation according to any one of examples EX1 to EX11 and EX15 to EX259 or a cartridge according to any one of examples EX12 to EX259 wherein the liquid carrier comprises glycerine and propylene glycol.
EX263: A liquid nicotine formulation according to any one of examples EX1 to EX11 and EX15 to EX259 or a cartridge according to any one of examples EX12 to EX259 wherein the liquid carrier comprises vegetable glycerine and propylene glycol.
EX264: A liquid nicotine formulation according to example EX262 or EX263 or a cartridge according to example EX262 or EX263 wherein the ratio of the weight percent glycerine content to the weight percent propylene glycol content of the liquid nicotine formulation is greater than or equal to about 0.2:1.
EX265: A liquid nicotine formulation according to example EX262 or EX263 or a cartridge according to example EX262 or EX263 wherein the ratio of the weight percent glycerine content to the weight percent propylene glycol content of the liquid nicotine formulation is greater than or equal to about 0.4:1.
EX266: A liquid nicotine formulation according to example EX262 or EX263 or a cartridge according to example EX262 or EX263 wherein the ratio of the weight percent glycerine content to the weight percent propylene glycol content of the liquid nicotine formulation is greater than or equal to about 0.6:1.
EX267: A liquid nicotine formulation according to example EX262 or EX263 or a cartridge according to example EX262 or EX263 wherein the ratio of the weight percent glycerine content to the weight percent propylene glycol content of the liquid nicotine formulation is greater than or equal to about 0.8:1.
EX268: A liquid nicotine formulation according to example EX262 or EX263 or a cartridge according to example EX262 or EX263 wherein the ratio of the weight percent glycerine content to the weight percent propylene glycol content of the liquid nicotine formulation is greater than or equal to about 0.9:1.
EX269: A liquid nicotine formulation according to example EX262 or EX263 or a cartridge according to example EX262 or EX263 wherein the ratio of the weight percent glycerine content to the weight percent propylene glycol content of the liquid nicotine formulation is less than or equal to about 2:1.
EX270: A liquid nicotine formulation according to example EX262 or EX263 or a cartridge according to example EX262 or EX263 wherein the ratio of the weight percent glycerine content to the weight percent propylene glycol content of the liquid nicotine formulation is less than or equal to about 1.8:1.
EX271: A liquid nicotine formulation according to example EX262 or EX263 or a cartridge according to example EX262 or EX263 wherein the ratio of the weight percent glycerine content to the weight percent propylene glycol content of the liquid nicotine formulation is less than or equal to about 1.6:1.
EX272: A liquid nicotine formulation according to example EX262 or EX263 or a cartridge according to example EX262 or EX263 wherein the ratio of the weight percent glycerine content to the weight percent propylene glycol content of the liquid nicotine formulation is less than or equal to about 1.4:1.
EX273: A liquid nicotine formulation according to example EX262 or EX263 or a cartridge to the weight percent propylene glycol content of the liquid nicotine formulation is less than or equal to about 1.2:1.
EX274: A liquid nicotine formulation according to example EX262 or EX263 or a cartridge according to example EX262 or EX263 wherein the ratio of the weight percent glycerine content to the weight percent propylene glycol content of the liquid nicotine formulation is less than or equal to about 1.1:1.
EX275: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.2:1 and about 2:1.
EX276: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.2:1 and about 1.8:1.
EX277: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.2:1 and about 1.6:1.
EX278: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.2:1 and about 1.4:1.
EX279: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.2:1 about 1.2:1.
EX280: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.2:1 about 1.1:1.
EX281: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.4:1 and about 2:1.
EX282: A liquid nicotine formulation according to example EX262 or EX263 or a cartridge to the weight percent propylene glycol content of the liquid nicotine formulation is between about 0.4:1 and about 1.8:1.
EX283: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.4:1 and about 1.6:1.
EX284: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.4:1 and about 1.4:1.
EX285: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.4:1 about 1.2:1.
EX286: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.4:1 about 1.1:1.
EX287: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.6:1 and about 2:1.
EX288: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.6:1 and about 1.8:1.
EX289: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.6:1 and about 1.6:1.
EX290: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.6:1 and about 1.4:1.
EX291: A liquid nicotine formulation according to example EX262 or EX263 or a cartridge to the weight percent propylene glycol content of the liquid nicotine formulation is between about 0.6:1 about 1.2:1.
EX292: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.6:1 about 1.1:1.
EX293: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.8:1 and about 2:1.
EX294: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.8:1 and about 1.8:1.
EX295: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.8:1 and about 1.6:1.
EX296: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.8:1 and about 1.4:1.
EX297: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.8:1 about 1.2:1.
EX298: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.8:1 about 1.1:1.
EX299: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.9:1 and about 2:1.
EX300: A liquid nicotine formulation according to example EX262 or EX263 or a cartridge to the weight percent propylene glycol content of the liquid nicotine formulation is between about 0.9:1 and about 1.8:1.
EX301: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.9:1 and about 1.6:1.
EX302: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.9:1 and about 1.4:1.
EX303: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.9:1 about 1.2:1.
EX304: A liquid nicotine formulation according to example EX262 or EX263 or a cartridge according to example EX262 or EX263 wherein the ratio of the weight percent glycerine content to the weight percent propylene glycol content of the liquid nicotine formulation is between about 0.9:1 about 1.1:1.
EX305: A liquid nicotine formulation according to example EX262 or EX263 or a cartridge according to example EX262 or EX263 wherein the ratio of the weight percent glycerine content to the weight percent propylene glycol content of the liquid nicotine formulation is about 1:1.
EX306: A liquid nicotine formulation according to any one of examples EX259 to EX291 or a cartridge according to any one of examples EX259 to EX305 wherein the liquid nicotine formulation has a glycerine content of greater than or equal to about 20 percent by weight.
EX307: A liquid nicotine formulation according to any one of examples EX259 to EX305 or a cartridge according to any one of examples EX259 to EX305 wherein the liquid nicotine formulation has a glycerine content of greater than or equal to about 25 percent by weight.
EX308: A liquid nicotine formulation according to any one of examples EX259 to EX305 or a cartridge according to any one of examples EX259 to EX305 wherein the liquid nicotine formulation has a glycerine content of greater than or equal to about 30 percent by weight.
EX309: A liquid nicotine formulation according to any one of examples EX259 to EX305 or a cartridge according to any one of examples EX259 to EX305 wherein the liquid nicotine formulation has a glycerine content of less than or equal to about 60 percent by weight.
EX310: A liquid nicotine formulation according to any one of examples EX259 to EX305 or a cartridge according to any one of examples EX259 to EX305 wherein the liquid nicotine formulation has a glycerine content of less than or equal to about 55 percent by weight.
EX311: A liquid nicotine formulation according to any one of examples EX259 to EX305 or a cartridge according to any one of examples EX259 to EX305 wherein the liquid nicotine formulation has a glycerine content of less than or equal to about 50 percent by weight.
EX312: A liquid nicotine formulation according to any one of examples EX259 to EX305 or a cartridge according to any one of examples EX259 to EX305 wherein the liquid nicotine formulation has a glycerine content of between about 20 percent by weight and about 60 percent by weight.
EX313: A liquid nicotine formulation according to any one of examples EX259 to EX305 or a cartridge according to any one of examples EX259 to EX305 wherein the liquid nicotine formulation has a glycerine content of between about 20 percent by weight and about 55 percent by weight.
EX314: A liquid nicotine formulation according to any one of examples EX259 to EX305 or a cartridge according to any one of examples EX259 to EX305 wherein the liquid nicotine formulation has a glycerine content of between about 20 percent by weight and about 50 percent by weight.
EX315: A liquid nicotine formulation according to any one of examples EX259 to EX305 or a cartridge according to any one of examples EX259 to EX305 wherein the liquid nicotine formulation has a glycerine content of between about 25 percent by weight and about 60 percent by weight.
EX316: A liquid nicotine formulation according to any one of examples EX259 to EX305 or a cartridge according to any one of examples EX259 to EX305 wherein the liquid nicotine formulation has a glycerine content of between about 25 percent by weight and about 55 percent by weight.
EX317: A liquid nicotine formulation according to any one of examples EX259 to EX305 or a cartridge according to any one of examples EX259 to EX305 wherein the liquid nicotine formulation has a glycerine content of between about 25 percent by weight and about 50 percent by weight.
EX318: A liquid nicotine formulation according to any one of examples EX259 to EX305 or a cartridge according to any one of examples EX259 to EX305 wherein the liquid nicotine formulation has a glycerine content of between about 30 percent by weight and about 60 percent by weight.
EX319: A liquid nicotine formulation according to any one of examples EX259 to EX305 or a cartridge according to any one of examples EX259 to EX305 wherein the liquid nicotine formulation has a glycerine content of between about 30 percent by weight and about 55 percent by weight.
EX320: A liquid nicotine formulation according to any one of examples EX259 to EX305 or a cartridge according to any one of examples EX259 to EX305 wherein the liquid nicotine formulation has a glycerine content of between about 30 percent by weight and about 50 percent by weight.
EX321: A liquid nicotine formulation according to any one of examples EX259 to EX320 or a cartridge according to any one of examples EX259 to EX320 wherein the liquid nicotine formulation has a propylene glycol content of greater than or equal to about 20 percent by weight.
EX322: A liquid nicotine formulation according to any one of examples EX259 to EX320 or a cartridge according to any one of examples EX259 to EX320 wherein the liquid nicotine formulation has a propylene glycol content of greater than or equal to about 25 percent by weight.
EX323: A liquid nicotine formulation according to any one of examples EX259 to EX320 or a cartridge according to any one of examples EX259 to EX320 wherein the liquid nicotine formulation has a propylene glycol content of greater than or equal to about 30 percent by weight.
EX324: A liquid nicotine formulation according to any one of examples EX259 to EX320 or a cartridge according to any one of examples EX259 to EX320 wherein the liquid nicotine formulation has a propylene glycol content of less than or equal to about 60 percent by weight.
EX325: A liquid nicotine formulation according to any one of examples EX259 to EX320 or a cartridge according to any one of examples EX259 to EX320 wherein the liquid nicotine formulation has a propylene glycol content of less than or equal to about 55 percent by weight.
EX326: A liquid nicotine formulation according to any one of examples EX259 to EX320 or a cartridge according to any one of examples EX259 to EX320 wherein the liquid nicotine formulation has a propylene glycol content of less than or equal to about 50 percent by weight.
EX327: A liquid nicotine formulation according to any one of examples EX259 to EX320 or a cartridge according to any one of examples EX259 to EX320 wherein the liquid nicotine formulation has a propylene glycol content of between about 20 percent by weight and about 60 percent by weight.
EX328: A liquid nicotine formulation according to any one of examples EX259 to EX320 or a cartridge according to any one of examples EX259 to EX320 wherein the liquid nicotine formulation has a propylene glycol content of between about 20 percent by weight and about 55 percent by weight.
EX329: A liquid nicotine formulation according to any one of examples EX259 to EX320 or a cartridge according to any one of examples EX259 to EX320 wherein the liquid nicotine formulation has a propylene glycol content of between about 20 percent by weight and about 50 percent by weight.
EX330: A liquid nicotine formulation according to any one of examples EX259 to EX320 or a cartridge according to any one of examples EX259 to EX320 wherein the liquid nicotine formulation has a propylene glycol content of between about 25 percent by weight and about 60 percent by weight.
EX331: A liquid nicotine formulation according to any one of examples EX259 to EX320 or a cartridge according to any one of examples EX259 to EX320 wherein the liquid nicotine formulation has a propylene glycol content of between about 25 percent by weight and about 55 percent by weight.
EX332: A liquid nicotine formulation according to any one of examples EX259 to EX320 or a cartridge according to any one of examples EX259 to EX320 wherein the liquid nicotine formulation has a propylene glycol content of between about 25 percent by weight and about 50 percent by weight.
EX333: A liquid nicotine formulation according to any one of examples EX259 to EX320 or a cartridge according to any one of examples EX259 to EX320 wherein the liquid nicotine formulation has a propylene glycol content of between about 30 percent by weight and about 60 percent by weight.
EX334: A liquid nicotine formulation according to any one of examples EX259 to EX320 or a cartridge according to any one of examples EX259 to EX320 wherein the liquid nicotine formulation has a propylene glycol content of between about 30 percent by weight and about 55 percent by weight.
EX335: A liquid nicotine formulation according to any one of examples EX259 to EX320 or a cartridge according to any one of examples EX259 to EX320 wherein the liquid nicotine formulation has a propylene glycol content of between about 30 percent by weight and about 50 percent by weight.
EX336: A liquid nicotine formulation according to any one of examples EX259 to EX335 or a cartridge according to any one of examples EX259 to EX335 wherein the liquid nicotine formulation has a combined glycerine and propylene glycol content of greater than or equal to about 60 percent by weight.
EX337: A liquid nicotine formulation according to any one of examples EX259 to EX335 or a cartridge according to any one of examples EX259 to EX335 wherein the liquid nicotine formulation has a combined glycerine and propylene glycol content of greater than or equal to about 70 percent by weight.
EX338: A liquid nicotine formulation according to any one of examples EX259 to EX335 or a cartridge according to any one of examples EX259 to EX335 wherein the liquid nicotine formulation has a combined glycerine and propylene glycol content of greater than or equal to about 80 percent by weight.
EX339: A liquid nicotine formulation according to any one of examples EX259 to EX335 or a cartridge according to any one of examples EX259 to EX335 wherein the liquid nicotine formulation has a combined glycerine and propylene glycol content of greater than or equal to about 85 percent by weight.
EX340: A liquid nicotine formulation according to any one of examples EX259 to EX335 or a cartridge according to any one of examples EX259 to EX335 wherein the liquid nicotine formulation has a combined glycerine and propylene glycol content of greater than or equal to about 90 percent by weight.
EX341: A liquid nicotine formulation according to any one of examples EX259 to EX335 or a cartridge according to any one of examples EX259 to EX335 wherein the liquid nicotine formulation has a combined glycerine and propylene glycol content of less than or equal to about 99 percent by weight.
EX342: A liquid nicotine formulation according to any one of examples EX259 to EX335 or a cartridge according to any one of examples EX259 to EX335 wherein the liquid nicotine formulation has a combined glycerine and propylene glycol content of less than or equal to about 97 percent by weight.
EX343: A liquid nicotine formulation according to any one of examples EX259 to EX335 or a cartridge according to any one of examples EX259 to EX335 wherein the liquid nicotine formulation has a combined glycerine and propylene glycol content of less than or equal to about 95 percent by weight.
EX344: A liquid nicotine formulation according to any one of examples EX259 to EX335 or a cartridge according to any one of examples EX259 to EX335 wherein the liquid nicotine formulation has a combined glycerine and propylene glycol content of between about 60 percent by weight and about 99 percent by weight.
EX345: A liquid nicotine formulation according to any one of examples EX259 to EX335 or a cartridge according to any one of examples EX259 to EX335 wherein the liquid nicotine formulation has a combined glycerine and propylene glycol content of between about 60 percent by weight and about 97 percent by weight.
EX346: A liquid nicotine formulation according to any one of examples EX259 to EX335 or a cartridge according to any one of examples EX259 to EX335 wherein the liquid nicotine formulation has a combined glycerine and propylene glycol content of between about 60 percent by weight and about 95 percent by weight.
EX347: A liquid nicotine formulation according to any one of examples EX259 to EX335 or a cartridge according to any one of examples EX259 to EX335 wherein the liquid nicotine formulation has a combined glycerine and propylene glycol content of between about 70 percent by weight and about 99 percent by weight.
EX348: A liquid nicotine formulation according to any one of examples EX259 to EX335 or a cartridge according to any one of examples EX259 to EX335 wherein the liquid nicotine formulation has a combined glycerine and propylene glycol content of between about 70 percent by weight and about 97 percent by weight.
EX349: A liquid nicotine formulation according to any one of examples EX259 to EX335 or a cartridge according to any one of examples EX259 to EX335 wherein the liquid nicotine formulation has a combined glycerine and propylene glycol content of between about 70 percent by weight and about 95 percent by weight.
EX350: A liquid nicotine formulation according to any one of examples EX259 to EX335 or a cartridge according to any one of examples EX259 to EX335 wherein the liquid nicotine formulation has a combined glycerine and propylene glycol content of between about 80 percent by weight and about 99 percent by weight.
EX351: A liquid nicotine formulation according to any one of examples EX259 to EX335 or a cartridge according to any one of examples EX259 to EX335 wherein the liquid nicotine formulation has a combined glycerine and propylene glycol content of between about 80 percent by weight and about 97 percent by weight.
EX352: A liquid nicotine formulation according to any one of examples EX259 to EX335 or a cartridge according to any one of examples EX259 to EX335 wherein the liquid nicotine formulation has a combined glycerine and propylene glycol content of between about 80 percent by weight and about 95 percent by weight.
EX353: A liquid nicotine formulation according to any one of examples EX259 to EX335 or a cartridge according to any one of examples EX259 to EX335 wherein the liquid nicotine formulation has a combined glycerine and propylene glycol content of between about 85 percent by weight and about 99 percent by weight.
EX354: A liquid nicotine formulation according to any one of examples EX259 to EX335 or a cartridge according to any one of examples EX259 to EX335 wherein the liquid nicotine formulation has a combined glycerine and propylene glycol content of between about 85 percent by weight and about 97 percent by weight.
EX355: A liquid nicotine formulation according to any one of examples EX259 to EX335 or a cartridge according to any one of examples EX259 to EX335 wherein the liquid nicotine formulation has a combined glycerine and propylene glycol content of between about 85 percent by weight and about 95 percent by weight.
EX356: A liquid nicotine formulation according to any one of examples EX259 to EX335 or a cartridge according to any one of examples EX259 to EX335 wherein the liquid nicotine formulation has a combined glycerine and propylene glycol content of between about 90 percent by weight and about 99 percent by weight.
EX357: A liquid nicotine formulation according to any one of examples EX259 to EX335 or a cartridge according to any one of examples EX259 to EX335 wherein the liquid nicotine formulation has a combined glycerine and propylene glycol content of between about 90 percent by weight and about 97 percent by weight.
EX358: A liquid nicotine formulation according to any one of examples EX259 to EX335 or a cartridge according to any one of examples EX259 to EX335 wherein the liquid nicotine formulation has a combined glycerine and propylene glycol content of between about 90 percent by weight and about 95 percent by weight.
EX359: A liquid nicotine formulation according to any one of examples EX1 to EX11 and EX15 to EX358 or a cartridge according to any one of examples EX12 to EX358 wherein the liquid carrier is substantially water-free.
EX360: A liquid nicotine formulation according to any one of examples EX1 to EX11 and EX15 to EX358 or a cartridge according to any one of examples EX12 to EX358 wherein the liquid carrier comprises water.
EX361: A liquid nicotine formulation according to example EX360 or a cartridge according to example EX360 wherein the liquid nicotine formulation has a water content of greater than or equal to about 1 percent by weight.
EX362: A liquid nicotine formulation according to example EX360 or a cartridge according to example EX360 wherein the liquid nicotine formulation has a water content of greater than or equal to about 2 percent by weight.
EX363: A liquid nicotine formulation according to example EX360 or a cartridge according to example EX360 wherein the liquid nicotine formulation has a water content of greater than or equal to about 3 percent by weight.
EX364: A liquid nicotine formulation according to example EX360 or a cartridge according to example EX360 wherein the liquid nicotine formulation has a water content of less than or equal to about 20 percent by weight.
EX365: A liquid nicotine formulation according to example EX360 or a cartridge according to example EX360 wherein the liquid nicotine formulation has a water content of less than or equal to about 15 percent by weight.
EX366: A liquid nicotine formulation according to example EX360 or a cartridge according to example EX360 wherein the liquid nicotine formulation has a water content of less than or equal to about 10 percent by weight.
EX367: A liquid nicotine formulation according to example EX360 or a cartridge according to example EX360 wherein the liquid nicotine formulation has a water content of less than or equal to about 6 percent by weight.
EX368: A liquid nicotine formulation according to example EX360 or a cartridge according to example EX360 wherein the liquid nicotine formulation has a water content of between about 1 percent by weight and about 20 percent by weight.
EX369: A liquid nicotine formulation according to example EX360 or a cartridge according to example EX360 wherein the liquid nicotine formulation has a water content of between about 1 percent by weight and about 15 percent by weight.
EX370: A liquid nicotine formulation according to example EX360 or a cartridge according to example EX360 wherein the liquid nicotine formulation has a water content of between about 1 percent by weight and about 10 percent by weight.
EX371: A liquid nicotine formulation according to example EX360 or a cartridge according to example EX360 wherein the liquid nicotine formulation has a water content of between about 1 percent by weight and about 6 percent by weight.
EX372: A liquid nicotine formulation according to example EX360 or a cartridge according to example EX360 wherein the liquid nicotine formulation has a water content of between about 2 percent by weight and about 20 percent by weight.
EX373: A liquid nicotine formulation according to example EX360 or a cartridge according to example EX360 wherein the liquid nicotine formulation has a water content of between about 2 percent by weight and about 15 percent by weight.
EX374: A liquid nicotine formulation according to example EX360 or a cartridge according to example EX360 wherein the liquid nicotine formulation has a water content of between about 2 percent by weight and about 10 percent by weight.
EX375: A liquid nicotine formulation according to example EX360 or a cartridge according to example EX360 wherein the liquid nicotine formulation has a water content of between about 2 percent by weight and about 6 percent by weight.
EX376: A liquid nicotine formulation according to example EX360 or a cartridge according to example EX360 wherein the liquid nicotine formulation has a water content of between about 3 percent by weight and about 20 percent by weight.
EX377: A liquid nicotine formulation according to example EX360 or a cartridge according to example EX360 wherein the liquid nicotine formulation has a water content of between about 3 percent by weight and about 15 percent by weight.
EX378: A liquid nicotine formulation according to example EX360 or a cartridge according to example EX360 wherein the liquid nicotine formulation has a water content of between about 3 percent by weight and about 10 percent by weight.
EX379: A liquid nicotine formulation according to example EX360 or a cartridge according to example EX360 wherein the liquid nicotine formulation has a water content of between about 3 percent by weight and about 6 percent by weight.
EX380: A liquid nicotine formulation according to any one of examples EX1 to EX11 and EX15 to EX379 or a cartridge according to any one of examples EX12 to EX379 wherein the liquid nicotine formulation has a pH of greater than or equal to about 4.
EX381: A liquid nicotine formulation according to any one of examples EX1 to EX11 and EX15 to EX379 or a cartridge according to any one of examples EX12 to EX379 wherein the liquid nicotine formulation has a pH of greater than or equal to about 4.5.
EX382: A liquid nicotine formulation according to any one of examples EX1 to EX11 and EX15 to EX379 or a cartridge according to any one of examples EX12 to EX379 wherein the liquid nicotine formulation has a pH of greater than or equal to about 5.
EX383: A liquid nicotine formulation according to any one of examples EX1 to EX11 and EX15 to EX379 or a cartridge according to any one of examples EX12 to EX379 wherein the liquid nicotine formulation has a pH of less than or equal to about 7.5.
EX384: A liquid nicotine formulation according to any one of examples EX1 to EX11 and EX15 to EX379 or a cartridge according to any one of examples EX12 to EX379 wherein the liquid nicotine formulation has a pH of less than or equal to about 7.
EX385: A liquid nicotine formulation according to any one of examples EX1 to EX11 and EX15 to EX379 or a cartridge according to any one of examples EX12 to EX379 wherein the liquid nicotine formulation has a pH of less than or equal to about 6.5.
EX386: A liquid nicotine formulation according to any one of examples EX1 to EX11 and EX15 to EX379 or a cartridge according to any one of examples EX12 to EX379 wherein the liquid nicotine formulation has a pH of between about 4 and about 7.5.
EX387: A liquid nicotine formulation according to any one of examples EX1 to EX11 and EX15 to EX379 or a cartridge according to any one of examples EX12 to EX379 wherein the liquid nicotine formulation has a pH of between about 4 and about 7.
EX388: A liquid nicotine formulation according to any one of examples EX1 to EX11 and EX15 to EX379 or a cartridge according to any one of examples EX12 to EX379 wherein the liquid nicotine formulation has a pH of between about 4 and about 6.5.
EX389: A liquid nicotine formulation according to any one of examples EX1 to EX11 and EX15 to EX379 or a cartridge according to any one of examples EX12 to EX379 wherein the liquid nicotine formulation has a pH of between about 4.5 and about 7.5.
EX390: A liquid nicotine formulation according to any one of examples EX1 to EX11 and EX15 to EX379 or a cartridge according to any one of examples EX12 to EX379 wherein the liquid nicotine formulation has a pH of between about 4.5 and about 7.
EX391: A liquid nicotine formulation according to any one of examples EX1 to EX11 and EX15 to EX379 or a cartridge according to any one of examples EX12 to EX379 wherein the liquid nicotine formulation has a pH of between about 4.5 and about 6.5.
EX392: A liquid nicotine formulation according to any one of examples EX1 to EX11 and EX15 to EX379 or a cartridge according to any one of examples EX12 to EX379 wherein the liquid nicotine formulation has a pH of between about 5 and about 7.5.
EX393: A liquid nicotine formulation according to any one of examples EX1 to EX11 and EX15 to EX379 or a cartridge according to any one of examples EX12 to EX379 wherein the liquid nicotine formulation has a pH of between about 5 and about 7.
EX394: A liquid nicotine formulation according to any one of examples EX1 to EX11 and EX15 to EX379 or a cartridge according to any one of examples EX12 to EX379 wherein the liquid nicotine formulation has a pH of between about 5 and about 6.5.
EX395: A liquid nicotine formulation according to any one of examples EX1 to EX11 and EX15 to EX394 or a cartridge according to any one of examples EX12 to EX394 wherein the liquid nicotine formulation comprises one or more flavourants.
EX396: A liquid nicotine formulation according to example EX395 or a cartridge according to example EX395 wherein the liquid nicotine formulation has a flavourant content of greater than or equal to about 0.05 percent by weight.
EX397: A liquid nicotine formulation according to example EX395 or a cartridge according to example EX395 wherein the liquid nicotine formulation has a flavourant content of greater than or equal to about 0.15 percent by weight.
EX398: A liquid nicotine formulation according to example EX395 or a cartridge according to example EX395 wherein the liquid nicotine formulation has a flavourant content of greater than or equal to about 0.25 percent by weight.
EX399: A liquid nicotine formulation according to example EX395 or a cartridge according to example EX395 wherein the liquid nicotine formulation has a flavourant content of greater than or equal to about 0.5 percent by weight.
EX400: A liquid nicotine formulation according to example EX395 or a cartridge according to example EX395 wherein the liquid nicotine formulation has a flavourant content of greater than or equal to about 0.75 percent by weight.
EX401: A liquid nicotine formulation according to example EX395 or a cartridge according to example EX395 wherein the liquid nicotine formulation has a flavourant content of less than or equal to about 6 percent by weight.
EX402: A liquid nicotine formulation according to example EX395 or a cartridge according to example EX395 wherein the liquid nicotine formulation has a flavourant content of less than or equal to about 5 percent by weight.
EX403: A liquid nicotine formulation according to example EX395 or a cartridge according to example EX395 wherein the liquid nicotine formulation has a flavourant content of less than or equal to about 4 percent by weight.
EX404: A liquid nicotine formulation according to example EX395 or a cartridge according to example EX395 wherein the liquid nicotine formulation has a flavourant content of less than or equal to about 3 percent by weight.
EX405: A liquid nicotine formulation according to example EX395 or a cartridge according to example EX395 wherein the liquid nicotine formulation has a flavourant content of less than or equal to about 2 percent by weight.
EX406: A liquid nicotine formulation according to example EX395 or a cartridge according to example EX395 wherein the liquid nicotine formulation has a flavourant content of between about 0.05 percent by weight and about 6 percent by weight.
EX407: A liquid nicotine formulation according to example EX395 or a cartridge according to example EX395 wherein the liquid nicotine formulation has a flavourant content of between about 0.05 percent by weight and about 5 percent by weight.
EX408: A liquid nicotine formulation according to example EX395 or a cartridge according to example EX395 wherein the liquid nicotine formulation has a flavourant content of between about 0.05 percent by weight and about 4 percent by weight.
EX409: A liquid nicotine formulation according to example EX395 or a cartridge according to example EX395 wherein the liquid nicotine formulation has a flavourant content of between about 0.05 percent by weight and about 3 percent by weight.
EX410: A liquid nicotine formulation according to example EX395 or a cartridge according to example EX395 wherein the liquid nicotine formulation has a flavourant content of between about 0.05 percent by weight and about 2 percent by weight.
EX411: A liquid nicotine formulation according to example EX395 or a cartridge according to example EX395 wherein the liquid nicotine formulation has a flavourant content of between about 0.15 percent by weight and about 6 percent by weight.
EX412: A liquid nicotine formulation according to example EX395 or a cartridge according to example EX395 wherein the liquid nicotine formulation has a flavourant content of between about 0.15 percent by weight and about 5 percent by weight.
EX413: A liquid nicotine formulation according to example EX395 or a cartridge according to example EX395 wherein the liquid nicotine formulation has a flavourant content of between about 0.15 percent by weight and about 4 percent by weight.
EX414: A liquid nicotine formulation according to example EX395 or a cartridge according to example EX395 wherein the liquid nicotine formulation has a flavourant content of between about 0.15 percent by weight and about 3 percent by weight.
EX415: A liquid nicotine formulation according to example EX395 or a cartridge according to example EX395 wherein the liquid nicotine formulation has a flavourant content of between about 0.15 percent by weight and about 2 percent by weight.
EX416: A liquid nicotine formulation according to example EX395 or a cartridge according to example EX395 wherein the liquid nicotine formulation has a flavourant content of between about 0.25 percent by weight and about 6 percent by weight.
EX417: A liquid nicotine formulation according to example EX395 or a cartridge according to example EX395 wherein the liquid nicotine formulation has a flavourant content of between about 0.25 percent by weight and about 5 percent by weight.
EX418: A liquid nicotine formulation according to example EX395 or a cartridge according to example EX395 wherein the liquid nicotine formulation has a flavourant content of between about 0.25 percent by weight and about 4 percent by weight.
EX419: A liquid nicotine formulation according to example EX395 or a cartridge according to example EX395 wherein the liquid nicotine formulation has a flavourant content of between about 0.25 percent by weight and about 3 percent by weight.
EX420: A liquid nicotine formulation according to example EX395 or a cartridge according to example EX395 wherein the liquid nicotine formulation has a flavourant content of between about 0.25 percent by weight and about 2 percent by weight.
EX421: A liquid nicotine formulation according to example EX395 or a cartridge according to example EX395 wherein the liquid nicotine formulation has a flavourant content of between about 0.5 percent by weight and about 6 percent by weight.
EX422: A liquid nicotine formulation according to example EX395 or a cartridge according to example EX395 wherein the liquid nicotine formulation has a flavourant content of between about 0.5 percent by weight and about 5 percent by weight.
EX423: A liquid nicotine formulation according to example EX395 or a cartridge according to example EX395 wherein the liquid nicotine formulation has a flavourant content of between about 0.5 percent by weight and about 4 percent by weight.
EX424: A liquid nicotine formulation according to example EX395 or a cartridge according to example EX395 wherein the liquid nicotine formulation has a flavourant content of between about 0.5 percent by weight and about 3 percent by weight.
EX425: A liquid nicotine formulation according to example EX395 or a cartridge according to example EX395 wherein the liquid nicotine formulation has a flavourant content of between about 0.5 percent by weight and about 2 percent by weight.
EX426: A liquid nicotine formulation according to example EX395 or a cartridge according to example EX395 wherein the liquid nicotine formulation has a flavourant content of between about 0.75 percent by weight and about 6 percent by weight.
EX427: A liquid nicotine formulation according to example EX395 or a cartridge according to example EX395 wherein the liquid nicotine formulation has a flavourant content of between about 0.75 percent by weight and about 5 percent by weight.
EX428: A liquid nicotine formulation according to example EX395 or a cartridge according to example EX395 wherein the liquid nicotine formulation has a flavourant content of between about 0.75 percent by weight and about 4 percent by weight.
EX429: A liquid nicotine formulation according to example EX395 or a cartridge according to example EX395 wherein the liquid nicotine formulation has a flavourant content of between about 0.75 percent by weight and about 3 percent by weight.
EX430: A liquid nicotine formulation according to example EX395 or a cartridge according to example EX395 wherein the liquid nicotine formulation has a flavourant content of between about 0.75 percent by weight and about 2 percent by weight.
EX431: An aerosol-generating system comprising a cartridge according to any one of examples to EX12 to EX430; and an aerosol-generating device configured to be removably coupled to the cartridge.

The invention will now be further described, by way of example only, with reference to the following examples and accompanying drawings, in which:

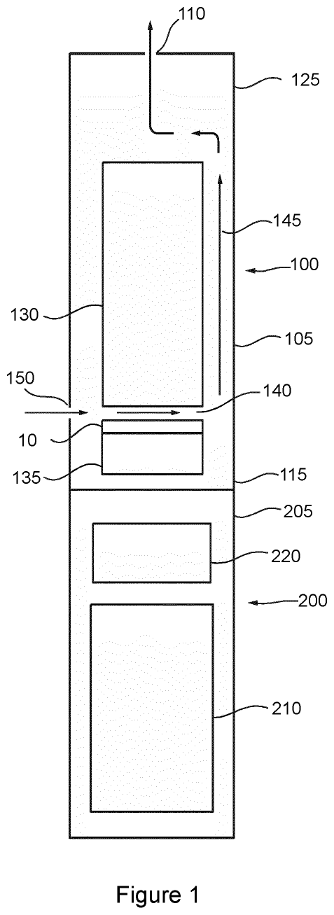

FIG. 1 is a schematic cross-sectional view of an aerosol-generating system comprising an aerosol-generating device and a cartridge according to an embodiment of the invention;

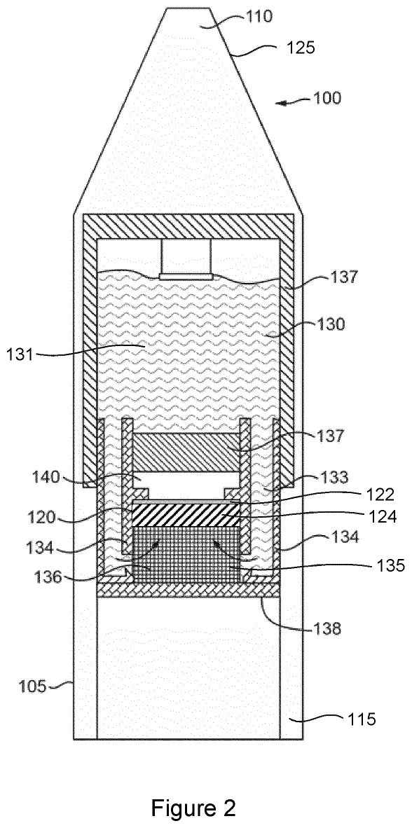

FIG. 2 is a schematic cross-sectional view of the cartridge of the aerosol-generating system FIG. 1; and

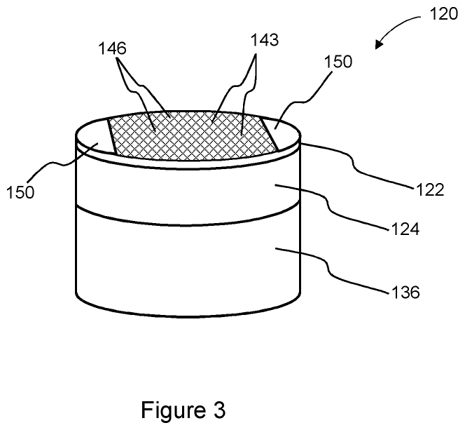

FIG. 3 is a schematic perspective view of the heater assembly and retention material of the cartridge of FIG. 2.

The aerosol-generating system shown in FIG. 1 comprises a cartridge 100 and an aerosol-generating device 200. A connection end 115 of the cartridge 100 is removably connected to a corresponding connection end 205 of the aerosol-generating device 200. The connection end 115 of the cartridge 100 and the connection end 205 of the aerosol-generating device 200 each have electrical contacts or connections (not shown) that are arranged to cooperate to provide an electrical connection between the cartridge 100 and the aerosol-generating device 200. The aerosol-generating device 200 contains a power supply in the form of a battery 210, such as a rechargeable lithium ion battery, and control circuitry 220. The aerosol-generating system is portable and has a size comparable to a combustible cigar or cigarette.

The cartridge 100 comprises a housing 105 containing a heater assembly 120 and a liquid storage compartment having a first storage portion 130 and a second storage portion 135. A liquid nicotine formulation (not shown in FIG. 1) is held in the liquid storage compartment.

Although not illustrated in FIG. 1, the first storage portion 130 of the liquid storage compartment is connected to the second storage portion 135 of the liquid storage compartment so that liquid nicotine formulation in the first storage portion 130 can pass to the second storage portion 135. The heater assembly 120 comprises a fluid permeable heating element and receives liquid nicotine formulation from the second storage portion 135 of the liquid storage compartment.

A mouthpiece 125 is arranged at the end of the cartridge 100 opposite the connection end 115 of the cartridge 100. An air flow passage 140, 145 extends through the cartridge 100 from an air inlet 150 formed in a side of the housing 105 of the cartridge 100, past the fluid permeable heating element of the heater assembly 120, and from the heater assembly 120 to a mouthpiece opening 110 formed in the housing 105 at an end of the cartridge 100 opposite to the connection end 115 of the cartridge 100.

The components of the cartridge 100 are arranged so that the first storage portion 130 of the liquid storage compartment is between the heater assembly 120 and the mouthpiece opening 110, and the second storage portion 135 of the liquid storage compartment is positioned on an opposite side of the heater assembly 120 to the mouthpiece opening 110. In other words, the heater assembly 120 is located between the first storage portion 130 and the second storage portion 135 of the liquid storage compartment and receives liquid nicotine formulation from the second storage portion 135 of the liquid storage compartment. The first storage portion 130 of the liquid storage compartment is closer to the mouthpiece opening 110 than the second storage portion 135 of the liquid storage compartment. The air flow passage 140, 145 extends past the fluid permeable heating element of the heater assembly 120 and between the first storage portion 130 and the second storage portion 135 of the liquid storage compartment.

The aerosol-generating system is configured so that a user can puff or draw on the mouthpiece 125 of the cartridge 100 to draw aerosol into their mouth through the mouthpiece opening 110. In operation, when a user puffs on the mouthpiece 125, air is drawn through the airflow passage 140, 145 from the air inlet 150, past the heater assembly 120, to the mouthpiece opening 110. The control circuitry 220 controls the supply of electrical power from the battery 210 to the cartridge 100 when the system is activated. This in turn controls the amount and properties of the vapour produced by the heater assembly 120. The control circuitry 220 may include an airflow sensor (not shown) and the control circuitry 220 may supply electrical power to the heater assembly 120 when user puffs are detected by the airflow sensor. This type of control arrangement is well established in aerosol-generating systems such as inhalers and e-cigarettes. When a user puffs on the mouthpiece opening 110 of the cartridge 100, the heater assembly 120 is activated and generates a vapour that is entrained in the air flow passing through the air flow passage 140. The vapour cools within the airflow passage 145 to form an aerosol, which is then drawn into the user's mouth through the mouthpiece opening 110.

In operation, the mouthpiece opening 110 is typically the highest point of the aerosol-generating system. The construction of the cartridge 100, and in particular the arrangement of the heater assembly 120 between the first storage portion 130 and the second storage portion 135 of the liquid storage compartment, is advantageous because it exploits gravity to ensure that the liquid nicotine formulation is delivered to the heater assembly 120 even as the liquid storage compartment is becoming empty, but prevents an oversupply of liquid nicotine formulation to the heater assembly 120 which might lead to leakage of liquid nicotine formulation into the air flow passage 140.

FIG. 2 is a schematic cross-sectional view of the cartridge 100 of the aerosol-generating system shown in FIG. 1. As described above, the housing 105 of the cartridge 100 contains a heater assembly 120 and a liquid storage compartment having a first storage portion 130 and a second storage portion 135. A liquid nicotine formulation 131 is held in the liquid storage compartment. The liquid nicotine formulation 131 comprises nicotine and a plurality of carboxylic acids comprising at least one carboxylic acid selected from the group consisting of benzoic acid and fumaric acid.

The cartridge 100 further comprises an upper storage compartment housing 137, a heater mount 134 and an end cap 138. The heater assembly 120 comprises a fluid permeable heating element 122 and a transport material 124 and is held in the heater mount 134. A retention material 136 is provided in the second portion 135 of the liquid storage compartment and abuts the transport material 124 of the heater assembly 120. The retention material 136 is configured to transport liquid nicotine formulation 131 to the transport material 124 of the heater assembly 120.

As shown in FIG. 2, the first portion 130 of the liquid storage compartment is larger than the second portion 135 of the liquid storage compartment and occupies a space between the heater assembly 120 and the mouthpiece opening 110 of the cartridge 100. Liquid nicotine formulation 131 in the first storage portion 130 of the liquid storage compartment can travel to the second storage portion 135 of the liquid storage compartment through liquid channels 133 on either side of the heater assembly 120. It will be appreciated that while two liquid channels are provided in the cartridge 100 shown in FIG. 2 in order to provide a symmetric structure, only one liquid channel is required. The liquid channels 133 are enclosed liquid flow paths defined between the storage compartment housing 137 and the heater mount 134.

The fluid permeable heating element 122 is arranged on a side of the heater assembly 120 facing the first storage portion 130 of the liquid storage compartment and the mouthpiece opening 110. The transport material 124 is arranged between the fluid permeable heating element 122 and the retention material 136. A first surface of the transport material 124 is in contact with the fluid permeable heating element 122 and an opposed second surface of the transport material is in contact with the retention material 136. The second surface of the transport material 124 faces the connection end 115 of the cartridge 100. The heater assembly 120 is closer to the connection end 115 of the cartridge 100 so that electrical connection of the heater assembly 120 to a power supply can be easily and robustly achieved.

An airflow passage 140 extends between the first storage portion 130 and the second storage portion 135 of the liquid storage compartment. As shown in FIG. 2, the fluid permeable heating element 122 forms a bottom wall of the airflow passage 140, a surface of the storage compartment housing 137 forms a top wall of the airflow passage and portions of the heater mount 134 form side walls of the airflow passage 140. An air flow passage 145 (not shown in FIG. 2) extends through the first storage portion 130 of the liquid storage compartment towards the mouthpiece opening 110.

FIG. 3 is a schematic perspective view of the heater assembly 120 and retention material 136 of the cartridge of FIG. 2. As shown in FIG. 3, the fluid permeable heating element 122 comprises a planar mesh heating element comprising an array of electrically conductive heating filaments 143 made from stainless steel. A plurality of interstices or apertures 146 are defined between the electrically conductive heating filaments 143 of the mesh heating element of the fluid permeable heating element 122. During heating, vaporised aerosol-forming substrate can be released from the heater assembly 120 via the apertures 146 to generate an aerosol. Further details of this type of heating element construction can be found in WO 2015/117702 A1.

As shown in FIG. 2, the transport material 124 and a portion of the retention material 136 are located within a tubular recess 132 formed in the heater mount 134. The fluid permeable heating element 122 extends across the tubular recess 132.

A first surface of the transport material 124 is in contact with the fluid permeable heating element 122 so as to provide fluid communication between the transport material 124 and the fluid permeable heating element 122 for liquid aerosol-generating substrate 131. A first portion of the retention material 136 is located within tubular recess 132 and abuts an opposed second surface of the transport material 124 such that the transport material 124 can receive liquid aerosol-generating substrate 131 from the retention material 136. A second portion of the retention material 136 extends outside the tubular recess 132 and is in fluid communication with the liquid channels 133 such that the second portion of the retention material 136 can receive liquid aerosol-generating liquid 131 from the liquid channels 133. The second portion of the retention material 136 abuts an end cap 138 which seals the lower end of the heater mount 134. The heater mount 134 may be injection moulded and may be formed from an engineering polymer such as polyetheretherketone (PEEK) or LCP (liquid crystal polymer). The fluid permeable heating element 122 extends outside the tubular recess 132 in a direction into and out of the plane of FIG. 1 such that opposing ends of the fluid permeable heating element 122 are located on the outside the heater mount 134.

As shown in FIG. 3, a pair of electrical contacts 150 are provided at each of the opposing ends of the heating element 122 for supplying electrical power to the fluid permeable heating element 122. The electrical contacts 150 comprise a pair of tin pads that are bonded directly to the fluid permeable heating element 122. While the electrical contacts 150 cover some of the apertures 146 of the fluid permeable heating element 122, this amounts to only a small proportion of the total number of apertures of the fluid permeable heating element 122 and does not significantly affect aerosol generation.

Both the transport material 124 and the retention material 136 are formed from capillary materials that retain and convey liquid nicotine formulation. As described above, the transport material 124 is in direct contact with the fluid permeable heating element 122. The transport material preferably has a higher thermal decomposition temperature (for example, a thermal decomposition of at least 160 degree Celsius or higher such as approximately 250 degree Celsius) than the retention material 136. The transport material 124 effectively acts as a spacer separating the fluid permeable heating element 122 from the retention material 136 so that the retention material 136 is not exposed to temperatures above its thermal decomposition temperature. The thermal gradient across the transport material 124 is such that the retention material 136 is only exposed to temperatures below its thermal decomposition temperature. The retention material 136 may be chosen to have superior wicking performance to the transport material 124 such that it retains more liquid nicotine formulation per unit volume than the transport material 124. The transport material 124 may be a heat resistant material such as, for example, glass fibre paper, cotton or treated cotton containing material or porous ceramic material. The retention material 136 may be a polymeric material such as, for example, high density polyethylene (HDPE), polyethylene terephthalate (PET) or polypropylene (PP)—polyethylene (PE) co-polyester fibres.

It will be appreciated that the cartridge 100 shown FIG. 2 is only one example of an embodiment of a cartridge for an aerosol-generating system according to the invention and that other embodiments are possible.

For example, it will be appreciated that in other embodiments the retention material may be omitted. In such embodiments, the transport material of the heater assembly may extend into the second storage portion of the liquid storage compartment to contact the liquid nicotine formulation contained therein.

It will also be appreciated that in other embodiments the fluid permeable heating element, the transport material and the retention material, where present, may be arranged at one end of the housing of the cartridge and the liquid storage compartment may be arranged at the other end of the cartridge.

### Examples A to D

Liquid nicotine formulations according to the first aspect of the invention are produced having the compositions shown in Examples A to D below:

Example A

| | |
|---|---|
| Component | % by weight |

| | | |
|---|---|---|
| Nicotine | | 3.50 |
| Benzoic Acid | Carboxylic acid | 0.53 |
| Lactic Acid | | 2.10 |
| Vegetable Glycerine | Liquid carrier | 56.9 |
| Propylene Glycol | | 35.0 |
| Water | | 2.0 |

| | |
|---|---|
| Molar ratio of total carboxylic acid to nicotine | 1.28:1 |
| Molar ratio of benzoic acid to nicotine | 0.20:1 |

Example B

| | |
|---|---|
| Component | % by weight |

| | | |
|---|---|---|
| Nicotine | | 3.30 |
| Benzoic Acid | Carboxylic acid | 0.90 |
| Fumaric Acid | | 0.80 |
| Vegetable Glycerine | Liquid carrier | 60.0 |
| Propylene Glycol | | 30.0 |
| Water | | 5.0 |

| | |
|---|---|
| Molar ratio of total carboxylic acid to nicotine | 0.70:1 |
| Molar ratio of benzoic acid to nicotine | 0.36:1 |
| Molar ratio of fumaric acid to nicotine | 0.34:1 |

Example C

| | |
|---|---|
| Component | % by weight |

| | | |
|---|---|---|
| Nicotine | | 3.50 |
| Fumaric Acid | Carboxylic acid | 1.50 |
| Lactic Acid | | 0.80 |
| Vegetable Glycerine | Liquid carrier | 51.2 |
| Propylene Glycol | | 40.0 |
| Water | | 3.0 |

| | |
|---|---|
| Molar ratio of total carboxylic acid to nicotine | 1:1 |
| Molar ratio of fumaric acid to nicotine | 0.60:1 |

Example D

| | |
|---|---|
| Component | % by weight |

| | | |
|---|---|---|
| Nicotine | | 3.50 |
| Benzoic Acid | Carboxylic acid | 1.0 |
| Fumaric Acid | | 0.5 |
| Lactic Acid | | 0.4 |
| Vegetable Glycerine | Liquid carrier | 35.0 |
| Propylene Glycol | | 49.6 |
| Water | | 10.0 |

| | |
|---|---|
| Molar ratio of total carboxylic acid to nicotine | 0.79:1 |
| Molar ratio of benzoic acid to nicotine | 0.38:1 |
| Molar ratio of fumaric acid to nicotine | 0.20:1 |

### Examples E and F

Cartridges according to the third aspect of the invention are produced comprising liquid nicotine formulations having the compositions shown in Examples A to D and Examples E and F below:

Example E

| | |
|---|---|
| Component | % by weight |

| | | |
|---|---|---|
| Nicotine | | 1.58 |
| Benzoic Acid | Carboxylic acid | 1.19 |
| Vegetable Glycerine | Liquid carrier | 47.2 |
| Propylene Glycol | | 44.0 |
| Water | | 6.0 |

| | |
|---|---|
| Molar ratio of benzoic acid to nicotine | 1:1 |

Example F

| | |
|---|---|
| Component | % by weight |

| | | |
|---|---|---|
| Nicotine | | 3.5 |
| Benzoic Acid | Carboxylic acid | 2.63 |
| Vegetable Glycerine | Liquid carrier | 43.4 |
| Propylene Glycol | | 43.4 |
| Water | | 7.0 |

| | |
|---|---|
| Molar ratio of benzoic acid to nicotine | 1:1 |

1.-15. (canceled)

16. A liquid nicotine formulation for an aerosol-generating system, the liquid nicotine formulation comprising:
nicotine;
a liquid carrier; and
a plurality of carboxylic acids,
wherein the plurality of carboxylic acids comprises benzoic acid and one or more carboxylic acids selected from the group consisting of acetic acid, adipic acid, fumaric acid, lactic acid, levulinic acid, malic acid, and succinic acid,
wherein a molar ratio of total carboxylic acid to nicotine in the liquid nicotine formulation is greater than or equal to about 0.65:1, and
wherein a molar ratio of benzoic acid to nicotine in the liquid nicotine formulation is greater than or equal to about 0.2:1.

17. The liquid nicotine formulation according to claim 16, wherein the plurality of carboxylic acids comprises lactic acid.

18. The liquid nicotine formulation according to claim 16, wherein the molar ratio of total carboxylic acid to nicotine in the liquid nicotine formulation is greater than or equal to about 0.7:1.

19. The liquid nicotine formulation according to claim 16, wherein the molar ratio of total carboxylic acid to nicotine in the liquid nicotine formulation is less than or equal to about 1.4:1.

20. The liquid nicotine formulation according to claim 16, wherein the molar ratio of total carboxylic acid to nicotine in the liquid nicotine formulation is less than or equal to about 1.3:1.

21. The liquid nicotine formulation according to claim 16, wherein the molar ratio of benzoic acid to nicotine in the liquid nicotine formulation is greater than or equal to about 0.3:1.

22. The liquid nicotine formulation according to claim 16, wherein the molar ratio of benzoic acid to nicotine in the liquid nicotine formulation is less than or equal to about 0.8:1.

23. The liquid nicotine formulation according to claim 16, wherein the molar ratio of benzoic acid to nicotine in the liquid nicotine formulation is less than or equal to about 0.7:1.

24. The liquid nicotine formulation according to claim 16, wherein the molar ratio of benzoic acid to total carboxylic acid in the liquid nicotine formulation is greater than or equal to about 0.2:1.

25. The liquid nicotine formulation according to claim 16, wherein the molar ratio of benzoic acid to total carboxylic acid in the liquid nicotine formulation is less than or equal to about 0.8:1.

26. The liquid nicotine formulation according to claim 16, wherein the liquid nicotine formulation has a total carboxylic acid content of between about 0.5 percent and about 3 percent by weight.

27. The liquid nicotine formulation according to claim 16, wherein the liquid carrier comprises glycerine and propylene glycol.

28. The liquid nicotine formulation according to claim 27, wherein a ratio of a weight percent glycerine content to a weight percent propylene glycol content of the liquid nicotine formulation is between about 0.8:1 about 1.2:1.

29. The liquid nicotine formulation according to claim 16, wherein the liquid carrier has a water content of between about 1 percent by weight and about 10 percent by weight.

30. A cartridge for an aerosol-generating system, the cartridge comprising:
a liquid storage portion comprising a liquid nicotine formulation according to claim 16; and
a fluid-permeable heating element in fluid communication with the liquid storage portion, wherein the fluid-permeable heating element comprises an electrically conductive mesh configured to vaporise the liquid nicotine formulation to generate an aerosol.
